(19) United States
(12) Patent Application Publication
(10) Pub. No.: US 2024/0143089 A1
(43) Pub. Date: May 2, 2024

(54) Digitized New Language, Input Method Therefor, and Input Tool Therefor

(71) Applicant: Qingchuan Huang, Ningde City (CN)

(72) Inventor: Qingchuan Huang, Ningde City (CN)

(21) Appl. No.: 18/492,468

(22) Filed: Oct. 23, 2023

Related U.S. Application Data
(63) Continuation of application No. PCT/CN2022/131277, filed on Nov. 11, 2022.

(30) Foreign Application Priority Data
Dec. 30, 2021 (CN) 202111683560.8

(51) Int. Cl. G06F 3/023; G06F 3/02; G06F 3/0354

(52) U.S. Cl. CPC G06F 3/0235; G06F 3/0219; G06F 3/03543

(57) ABSTRACT

A digitized new language, an input method therefor, and an input tool therefor, belong to the technical field of language digitization and input methods therefor. The characters of the digitized new language are ten Arabic numbers from 0 to 9 of the international universal code, the number of vowels and consonants for the phonetic notation in international intercommunication each ten. The digitized new language takes the 0-9 Arabic numerals as the unified characters of all languages in the world, and connects, by means of a literal meaning classification mode expressed by various languages all languages in series, and continues by means of word sounds, which makes understanding, teaching, translation, conversion, and input among different languages simple and smooth, and moreover, all the issues, such as computer input methods and tools of languages, programming, system development, wider application of the decimal system, dictionary arrangement, will be greatly innovated.

### CROSS-REFERENCE TO RELATED APPLICATIONS

This application is a Continuation of co-pending Application No. PCT/CN2022/131277 filed on Nov. 11, 2022, for which priority is claimed under 35 U.S.C. § 120; and this application claims priority of Application No. 202111683560.8 filed in China on Dec. 30, 2021, under 35 U.S.C. § 119; the entire contents of all of which are hereby incorporated by reference.

### TECHNICAL FIELD

The present invention relates to a digitized new language, input method therefor, and input tool therefor. The digitized new language includes the current digitized global language and the corresponding Braille and sign language, the newly created interpersonal language and interpersonal language Braille and sign language and the newly created interstellar language.

### BACKGROUND TECHNOLOGY

Language are the most important tool for interpersonal communication of ideas and dissemination of information; Language are created for interpersonal communication and should not become a barrier to interpersonal communication. Language, in a broad sense, include oral language and written language, while in a narrow sense, only refer to oral language. Oral language are also called spoken language. Written language are also called literary language generally. There are as many as thousands of language in the world, however most of them are only oral language rather than written language, That is to say, only a few language are both oral language and written language. Oral language refer to oral communication, which survive through the speech storage in people's memory. Many oral language have disappeared over time in the long river of history; Written language are preserved and passed down through written symbols. For language with only oral forms, written forms, namely literal forms can be created to record the history and past valuable events.

The diversity of language is a result of the isolation of human living areas and the lack of communication between different places. Regional isolation leads to different language. The current language are quite different, people from different countries, regions, nations and even the same region cannot understand each other's words; Due to the different written language learned and used, people cannot understand each other's written language, causing abnormal communication, losing the sense of closeness, reducing mutual trust and even leading to language discrimination and disputes. The current written language in the world are composed of different letters or stroke forms and the writing methods are various. A series of problems such as cognition, teaching, input, translation, conversion and so on exist among different written language, resulting in an incalculable waste of time, manpower and material resources every year.

Today, the word “Global Village” has become a very famous concept, however, people from different groups in the “same village” are using oral and written language that they do not understand each other. So far, according to the usage levels and scopes, language are usually divided into local language, official or all-purpose language of some countries and Interlingua used by different countries. Actually, there is no unified global Interlingua except a so called quasi Interlingua; For people only live in an area, their local language is sufficient for communication; When their communication go beyond the scope of the local language, they should learn their own official or all-purpose language; When it is necessary to communicate with other people who do not understand the official or all-purpose language, they should consider learning another national language. With the increasing international contacts, it has become an expectation to create an Interlingua that can be communicated among all countries. All artificial international auxiliary language that have appeared in the past used Latin letters as the word-formation symbols, that is to say, Latin letters as word-formation symbols have great advantages over other letters or stroke form construction symbols and are the most popular word-formation symbols in the world. However, they cannot break the constraints of the Latin alphabet language and can only “overcome” certain shortcomings of the current Latin alphabet language, creating another artificial Latin alphabet language without any breakthrough and failing to make any progress internationally. Breaking down the barriers and even misunderstandings in interpersonal communication caused by the differences among current language and achieving an easy-learning, easy-writing, fair and scientific international auxiliary or all-purpose language that transcends national boundaries, nations, races and traditions are major issues for the international community and global issues that urgently needs to be addressed.

The Brailles of visually impaired individuals and sign language of deaf-mute individuals in various countries are different means of communication from the language used by normal people, making it difficult to understand each other; The Brailles and sign language used by visually impaired and deaf-mute individuals in various countries around the world are also different, which not only hinders the normal communication among visually impaired individuals, deaf-mute individuals and normal people in the same country, but also affects the communication among visually impaired and deaf mute individuals in different countries.

The universe is vast and boundless. How many other planets have ‘humans’ just like on the Earth? How to search for the traces of extraterrestrial beings and communicate with them? With the rapid development of human science and technology on the Earth, the search for extraterrestrial beings is becoming increasingly urgent, but so far there has been no effective information on communicating with extraterrestrial “humans”.

The digitized new language inherits the phonetics and expressed contents of language, changes the writing forms, retains the roots of the created language of humans and highlights the soul of current language.

Only by achieving the unity of the word-formation symbols of current language can we achieve the unity of the global language. The digitized new language has taken a firm step towards achieving a unified language for human being in order to share the achievements of global integration and jointly explore extraterrestrial civilizations.

### SUMMARY OF THE INVENTION

Considering the shortcomings of the current language technology, the present invention provides a new language using ten Arabic numbers 0˜9 and covering the world's current language and their corresponding Brailles and sign language, the newly created interpersonal language and its Braille and sign language and the newly created interstellar language and its input method and tool.

### 1. Digitized New Language

The digitized new language uses ten Arabic numbers 0˜9 as the unified word-formation symbols (characters for short) for all language. The digitized new language is shortened as the new language and covers the digitized new current language and their corresponding Brailles and sign language, the newly created interpersonal language and their corresponding Brailles and sign language and the newly created interstellar language, wherein the characters are international codes within ten Arabic numbers 0˜9, the phonetic notation consists of internationally recognized ten consonants and ten vowels, and the pronunciations are mainly determined based on the internationally recognized phonetic symbols, namely 1, 2, 3, 4, 5, 6, 7 and \dot{1}.

Pronunciation table of characters within 0˜9 for the digitized new language:

| Character | 0 | 1 | 2 | 3 | 4 | 5 | 6 | 7 | 8 | 9 |
|---|---|---|---|---|---|---|---|---|---|---|
| Pron. | [be] | [d [symbol] ] | [lei] | [mi] | [fa] | [so] | [nai] | [tin] | [k [symbol] n] | [pu] |

The characters of the ten Arabic numbers (0-9) are the same globally, however they are different in pronunciation in different countries and regions. They are distinctive pronunciations, however under the overall trend of unified pronunciations, people using different language can also pronounce their own distinctive pronunciations, which reflect the combination of language in unity, discrepancy and diversity.

### 1) Characters of the Digitized New Language

The characters of the digitized new language comprise of phonetic symbols, semantic symbols and formal symbols.

### \textcircled{1} Phonetic Symbol

A phonetic symbol is the shortened title of a phonetic-class symbol. A phonetic symbol is the pronunciation part of a word. A word can have no semantic symbol or formal symbol, but it must be provided with a phonetic symbol. The phonetic symbols of a digitized new language categorize the pronunciation characteristics of current language, preserving the “charm” of the last syllable in the original language, inheriting the phonology of the original language, and the beautiful rhythm of traditional poetry, prose, and other literary styles will not be abandoned.

A total of 110 phonetic symbols are set, including 10 single-phonetic-symbols 0˜9 with no consonants before vowels, and 100 “consonant+vowel” combined double-phonetic-symbols ranging 00 to 99. Each word has 1˜2 phonetic symbols.

Phonetic symbol table of the Digitized new language:

| | | Vowel characters 0~9 |
|---|---|---|
| Vowel sign | | a a: [symbol] ai an [symbol] ao au [symbol] |
| Double- | | e [symbol] ei en [symbol] er [symbol] |
| phonetic- | | i [symbol] I _{I} ia ian [symbol] iao [symbol] |
| symbol | | i: ie [symbol] in [symbol] iu [symbol] ju(:) [symbol] l m n |
| Consonant Mark sign | | o [symbol] ou Θ Φ œ [symbol] oi [symbol] |
| | | u [symbol] u: [symbol] ua uai uan [symbol] [symbol] [symbol] |
| | | ui un uo [symbol] w y Y ü ũan üe ün [symbol] |
| Consonant | b [symbol] B _{B}β [symbol] ch [symbol] | 00 01 02 03 04 05 06 07 08 09 |
| characters | d [symbol] dr dz [symbol] d³ [symbol] | 10 11 12 13 14 15 16 17 18 19 |
| 0~9 | g [symbol] g G G [symbol] h ^{h} H H [symbol] | 20 21 22 23 24 25 26 27 28 29 |
| | [symbol] k [symbol] | 30 31 32 33 34 35 36 37 38 39 |
| | [symbol] | 40 41 42 43 44 45 46 47 48 49 |
| | m [symbol] n ⁿ N N [symbol] | 50 51 52 53 54 55 56 57 58 59 |
| | [symbol] P [symbol] q [symbol] | 60 61 62 63 64 65 66 67 68 69 |
| | r R _{R} [symbol] | 70 71 72 73 74 75 76 77 78 79 |
| | s ^{s} S [symbol] sh [symbol] | 80 81 82 83 84 85 86 87 88 89 |
| | [symbol] T tr ts [symbol] | 90 91 92 93 94 95 96 97 98 99 |
| | w ^{w} [symbol] x ^{x} x T y Y Y [symbol] | |
| | z [symbol] zh [symbol] | |

For example: The single-phonetic-symbol 0 contains [a:], [æ], [ [symbol] ] (or [ [symbol] ]) (English), a ia/ya ua/wa eng ueng/weng (Chinese), . . . ;
The double-phonetic-symbol 00 contains [ba:], [da:], [dra:], [d 3 a:], [fa:], [ga:], [ha:], [ja:], [ka:], [la:] (English), ba, ca, cha (Chinese), . . . ;
10 contains [ma:], [na:], [ða:], [pa:], [ra:], [sa:], [ [symbol] a:], [ta:], [tra:], [t [symbol] a:], [va:], [wa:], [za:], (English), da, fa, ga, ha, ka, la (Chinese), . . . ;
20 contains [bæ], [dæ], [dræ], [d3æ], [hæ] (English), ma, na, pa, ta (Chinese), . . . ;
30 contains [fæ], [gæ], [jæ], [læ] (English), sa, sha, za, zha (Chinese), . . . ;
40 contains [kæ], [mæ], [næ], [θæ], [ðæ)], [pæ] (English), clia, Jia, lia, qia, xia (Chinese), . . . ;
50 contains [ræ], [sæ], [ [symbol] æ], [tæ], [træ], [t [symbol] æ], [væ], [wæ], [zæ] (English), gua, hua, kua, shua, zhua (Chinese), . . . ;
60 contains [ [symbol] ], [ [symbol] ], [ [symbol] ], [ [symbol] ], [ [symbol] ], [ [symbol] ], [ [symbol] ], [ [symbol] ], (English), beng, ceng, cheng, deng (Chinese), . . . ;
70 contains [ [symbol] ], [l [symbol] ], [ [symbol] ], (English), feng, geng, heng, keng, leng (Chinese), . . . ;
80 contains [ [symbol] ], [ [symbol] ], [ [symbol] ], [ [symbol] ] (English), meng, neng, peng, seng, sheng (Chinese), . . . ;
90 contains [ [symbol] ], [ [symbol] ], [ [symbol] ], [ [symbol] ], [ [symbol] ], [ [symbol] ], [ [symbol] ], [ [symbol] ] (English), reng, teng, zeng, zheng (Chinese), . . . .

The digitized new language also digitizes the pronunciations of current language according to the “Phonetic symbol table of the digitized new language”, using only phonetic symbols rather than semantic symbols; In any language, each word has at most 3 syllables and 6 characters, with the last syllable being indispensable. For example, 1000 (New Arabic): [symbol] peace” (Arabic), \dot{2} (New Irish): “éanbird” (Irish), 101010 (New Sanskrit): [symbol] time” (Sanskrit), 6018 (New Cambodian): “ [symbol] toilet” (Cambodian), 58 (New Portuguese): “som sound” (Portuguese), 72 (New Hungarian): “zseb pocket” (Hungarian), 5070 (New English): “enthusiast, enthusiast” (English).

### \textcircled{2} Semantic Symbol

A semantic symbol is the shortened title of a semantic class symbol. Although the current language of human being are different word form, pronunciation, grammar, etc., regardless of their linguistic forms, the meanings they express are interrelated and their contents are interconnected. The semantic symbols are classified according to the word meanings of different language. A semantic symbol has its own related meanings. Connecting various current language through the same semantic symbols to run through the ancient and modern times of various human language forms the central nervous system that governs the meanings of all current language words for understanding their overall meanings through word forms, which is similar to the roles of the radicals of Chinese characters and the roots of pinyin characters.

The semantic symbols comprise of 110 categories, including 10 categories of single-semantic-symbols and 100 categories of double-semantic-symbols. The identifier of the semantic symbols is “\dot{ }”, For a single-semantic-symbol, it can be added above it; For a double-semantic-symbol, it can be added above the second semantic symbol. Semantic symbol vowels are pronounced with a long sound [:], 0 [be:], 1 [ [symbol] :], 2 [lei:], 3 [mi:], 4 [fa:], 5 [so:], 6 [nai:], 7 [ti: n], 8 [ [symbol] :n] and 9 [pu:].

Semantic symbol table of the digitized new language:

| Semantic | |
|---|---|
| sym. | |
| Consonant | |
| Mark | Semantic classification |
| \dot{⁰} | Related to people |
| \dot{¹} | Related to brain and heart |
| \dot{²} | Related to mouth |
| \dot{³} | Related to speech |
| \dot{⁴} | Related to hands |
| \dot{⁵} | Related to walking |
| \dot{⁶} | Related to metals |
| \dot{⁷} | Related to trees |
| \dot{⁸} | Related to water |
| \dot{⁹} | Related to grass and flowers |
| 0\dot{⁰} | Related to parents |
| 0\dot{¹} | Related to children |
| 0\dot{²} | Related to women |
| 0\dot{³} | Related to the body |
| 0\dot{⁴} | Related to head |
| 0\dot{⁵} | Related to angles |
| 0\dot{⁶} | Related to ear |
| 0\dot{⁷} | Related to sound |
| 0\dot{⁸} | Related to face |
| 0\dot{⁹} | Related to eyes |
| 1\dot{⁰} | Related to seeing |
| 1\dot{¹} | Related to nose |
| 1\dot{²} | Related to fragrance |
| 1\dot{³} | Related to open mouth breathing |
| 1\dot{⁴} | Related to tongue |
| 1\dot{⁵} | Related to saline tastes |
| 1\dot{⁶} | Related to spicy tastes |
| 1\dot{⁷} | Related to teeth |
| 1\dot{⁸} | Related to bone |
| 1\dot{⁹} | Related to blood |
| 2\dot{⁰} | Related to meat |
| 2\dot{¹} | Related to skin |
| 2\dot{²} | Related to hair |
| 2\dot{³} | Related to wings |
| 2\dot{⁴} | Related to knocking |
| 2\dot{⁵} | Related to claws |
| 2\dot{⁶} | Related to feet |
| 2\dot{⁷} | Related to standing |
| 2\dot{⁸} | Related to horses |
| 2\dot{⁹} | Related to cattle |
| 3\dot{⁰} | Related to sheep |
| 3\dot{¹} | Related to pigs |
| 3\dot{²} | Related to dogs |
| 3\dot{³} | Related to mice |
| 3\dot{⁴} | Related to tigers |
| 3\dot{⁵} | Related to deer |
| 3\dot{⁶} | Related to wild animals |
| 3\dot{⁷} | Related to birds |
| 3\dot{⁸} | Related to insects |
| 3\dot{⁹} | Related to fish |
| 4\dot{⁰} | Related to tortoises and frogs |
| 4\dot{¹} | Related to growth |
| 4\dot{²} | Related to force |
| 4\dot{³} | Related to diseases |
| 4\dot{⁴} | Related to bad luck |
| 4\dot{⁵} | Related to ghosts |
| 4\dot{⁶} | Related to God |
| 4\dot{⁷} | Related to clothing |
| 4\dot{⁸} | Related to silk thread |
| 4\dot{⁹} | Related to cloth and silk |
| 5\dot{⁰} | Related to hide |
| 5\dot{¹} | Related to food |
| 5\dot{²} | Related to paddy |
| 5\dot{³} | Related to grain |
| 5\dot{⁴} | Related to wheat |
| 5\dot{⁵} | Related to melons and beans |
| 5\dot{⁶} | Related to wine |
| 5\dot{⁷} | Related to doors |
| 5\dot{⁸} | Related to furnishings |
| 5\dot{⁹} | Related to factory buildings |
| 6\dot{⁰} | Related to caves |
| 6\dot{¹} | Related to urban and rural areas |
| 6\dot{²} | Related to vehicles |
| 6\dot{³} | Related to boats |
| 6\dot{⁴} | Related to bottle/can appliances |
| 6\dot{⁵} | Related to dishes and utensils |
| 6\dot{⁶} | Related to containers |
| 6\dot{⁷} | Related to cooking utensils |
| 6\dot{⁸} | Related to measuring instruments |
| 6\dot{⁹} | Related to nets |
| 7\dot{⁰} | Related to agricultural tools |
| 7\dot{¹} | Related to tools |
| 7\dot{²} | Related to axe |
| 7\dot{³} | Related to spears |
| 7\dot{⁴} | Related to bows and crossbows |
| 7\dot{⁵} | Related to arrows |
| 7\dot{⁶} | Related to the sun |
| 7\dot{⁷} | Related to the moon |
| 7\dot{⁸} | Related to evening and night |
| 7\dot{⁹} | Related to photoelectricity |
| 8\dot{⁰} | Related to fire |
| 8\dot{¹} | Related to air |
| 8\dot{²} | Related to wind |
| 8\dot{³} | Related to rain |
| 8\dot{⁴} | Related to coldness |
| 8\dot{⁵} | Related to jade |
| 8\dot{⁶} | Related to stones |
| 8\dot{⁷} | Related to mountains |
| 8\dot{⁸} | Related to farmland |
| 8\dot{⁹} | Related to soils |
| 9\dot{⁰} | Related to hills |
| 9\dot{¹} | Related to bamboo |
| 9\dot{²} | Related to slice |
| 9\dot{³} | Related to colors |
| 9\dot{⁴} | Related to cyan and red |
| 9\dot{⁵} | Related to yellow and white |
| 9\dot{⁶} | Related to black |
| 9\dot{⁷} | Related to money and commodities |
| 9\dot{⁸} | Related to roads |
| 9\dot{⁹} | Related to directions and flags |

For example:
\dot{0} is equivalent to Radical [symbol] in Chinese and “man” in English; \dot{1} is equivalent to Radicals [symbol] in Chinese and the “brain, heart” in English;
\dot{2} is equivalent to Radical [symbol] in Chinese and “mouth” in English; \dot{3} is equivalent to Radical [symbol] in Chinese and “speech” in English;
\dot{4} is equivalent to Radical [symbol] in Chinese and “hand” in English; \dot{5} is equivalent to Radicals [symbol] and [symbol] in Chinese and “walk” in English;
\dot{6} is equivalent to Radical [symbol] in Chinese and “metal” in English; \dot{7} is equivalent to Radical [symbol] in Chinese and “tree, wood” in English;
\dot{8} is equivalent to Radical [symbol] in Chinese and “water” in English; \dot{9} is equivalent to Radica [symbol] in Chinese and “grass, flower” in English;
0\dot{0} is equivalent to Raclicals [symbol] in Chinese and “father, mother” in English; 0\dot{1} is equivalent to Radicals [symbol] in Chinese and “child, son” in English;
0\dot{2} is equivalent to Radical [symbol] in Chinese and “female” in English; 0\dot{3} is equivalent to Radicals [symbol] in Chinese and “body” in English;
0\dot{4} is equivalent to Raclicals [symbol] in Chinese and “head” in English; 0\dot{5} is equivalent to Radical [symbol] in Chinese and “horn” in English;
0\dot{6} is equivalent to Radical [symbol] in Chinese and “face” in English; 0\dot{7} is equivalent to Radical [symbol] in Chinese and “eye” in English;
0\dot{8} is equivalent to Radical [symbol] in Chinese and “see” in English; 0\dot{9} is equivalent to Radical [symbol] in Chinese and “ear” in English;
1\dot{0} is equivalent to Radicals [symbol] in Chinese and “sound” in English; 1\dot{1} is equivalent to Radicals [symbol] in Chinese and “nose” in English;
1\dot{2} is equivalent to Radical [symbol] in Chinese and “fragrant” in English; 1\dot{3} is equivalent to Radical [symbol] in Chinese and “yawn” in English;
1\dot{4} is equivalent to Radical [symbol] in Chinese and “tongue” in English; 1\dot{5} is equivalent to Radical [symbol] in Chinese and “bittern” in English;
1\dot{6} is equivalent to Radical [symbol] in Chinese and “pungent” in English; 1\dot{7} is equivalent to Radicals [symbol] in Chinese and “tooth” in English;
1\dot{8} is equivalent to Radical [symbol] in Chinese and “bone” in English; 1\dot{9} is equivalent to Radical [symbol] in Chinese and “blood” in English;
2\dot{0} is equivalent to Radical [symbol] in Chinese and “flesh” in English; 2\dot{1} is equivalent to Radical [symbol] in Chinese and “skin” in English;
2\dot{2} is equivalent to Radicals [symbol] in Chinese and “hair” in English; 2\dot{3} is equivalent to Radical [symbol] in Chinese and “feather” in English;
2\dot{4} is equivalent to Radicals [symbol] in Chinese and “beat” in English; 2\dot{5} is equivalent to Radical [symbol] in Chinese and “claw” in English;
2\dot{6} is equivalent to Radical [symbol] in Chinese and “foot” in English; 2\dot{7} is equivalent to Radical [symbol] in Chinese and “stand” in English;
2\dot{8} is equivalent to Radical [symbol] in Chinese and “horse” in English; 2\dot{9} is equivalent to Radical [symbol] in Chinese and “cattle” in English;
3\dot{0} is equivalent to Radical [symbol] in Chinese and “sheep (collectively known as sheep)” in English; 3\dot{1} is equivalent to Radical [symbol] in Chinese and “pig” in English;
3\dot{2} is equivalent to Radical [symbol] in Chinese and “dog” in English; 3\dot{3} is equivalent to Radical [symbol] in Chinese and “mouse” in English;
3\dot{4} is equivalent to Radical [symbol] in Chinese and “tiger” in English; 3\dot{5} is equivalent to Radicali [symbol] in Chinese and “deer” in English;
3\dot{6} is equivalent to Radical [symbol] in Chinese and “beast” in English; 3\dot{7} is equivalent to Radicals [symbol] in Chinese and “bird” in English;
3\dot{8} is equivalent to Radical [symbol] in Chinese and “worm” in English; 3\dot{9} is equivalent to Radical [symbol] in Chinese and “fish” in English;
4\dot{0} is equivalent to Radicals [symbol] in Chinese and “tortoise, frog” in English; 4\dot{1} is equivalent to Radical [symbol] in Chinese and “bear, grow” in English;
4\dot{2} is equivalent to Radical [symbol] in Chinese and “strength” in English; 4\dot{3} is equivalent to Radical [symbol] in Chinese and “illness” in English;
4\dot{4} is equivalent to Radical [symbol] in Chinese and “unlucky” in English; 4\dot{5} is equivalent to Radical [symbol] in Chinese and “ghost” in English;
4\dot{6} is equivalent to Radicalt [symbol] in Chinese and “god” in English; 4\dot{7} is equivalent to Radical [symbol] in Chinese and “clothes” in English;
4\dot{8} is equivalent to Radical [symbol] in Chinese and “silk” in English; 4\dot{9} is equivalent to Radical [symbol] in Chinese and “cloth” in English;
5\dot{0} is equivalent to Radicals [symbol] in Chinese and “leather” in English; 5\dot{1} is equivalent to Radical [symbol] in Chinese and “food” in English;
5\dot{2} is equivalent to Radical [symbol] in Chinese and “paddy” in English; 5\dot{3} is equivalent to Radical [symbol] in Chinese and “rice” in English;
5\dot{4} is equivalent to Radical [symbol] in Chinese and “wheat (collectively known as wheat)” in English; 5\dot{5} is equivalent to Radicals [symbol] Chinese and “melon, bean” in English;
5\dot{6} is equivalent to Radical [symbol] in Chinese and “wine (collectively known as wine)” in English; 5\dot{7} is equivalent to Radicals [symbol] in Chinese and “door” in English;
5\dot{8} is equivalent to Radicals [symbol] in Chinese and “home” in English; 59 is equivalent to Radicals [symbol] in Chinese and “factory, shed” in English;
6\dot{0} is equivalent to Radical [symbol] in Chinese and “cave” in English; 6\dot{1} is equivalent to Radical [symbol] in Chinese and “town” in English;
6\dot{2} is equivalent to Radical [symbol] in Chinese and “vehicle” in English; 6\dot{3} is equivalent to Radical [symbol] in Chinese and “boat” in English;
6\dot{4} is equivalent to Radicals [symbol] in Chinese and “tile, earthen jar” in English; 6\dot{5} is equivalent to Radical [symbol] in Chinese and “utensil” in English;
6\dot{6} is equivalent to Radical [symbol] in Chinese and “vessel” in English; 6\dot{7} is equivalent to Radicals [symbol] Chinese and “pot” in English;
6\dot{8} is equivalent to Radicals [symbol] in Chinese and “measure” in English; 6\dot{9} is equivalent to Radical [symbol] in Chinese and net in English;
7\dot{0} is equivalent to Radical [symbol] in Chinese and “farm tool” in English; 7\dot{1} is equivalent to Radical [symbol] in Chinese and “knife” in English;
7\dot{2} is equivalent to Radical [symbol] in Chinese and “axe” in English; 7\dot{3} is equivalent to Radicals [symbol] in Chinese and “pike, dagger-axe” in English;
7\dot{4} is equivalent to Radical [symbol] in Chinese and “bow” in English; 7\dot{5} is equivalent to Radical [symbol] in Chinese and “arrow” in English;
7\dot{6} is equivalent to Radical [symbol] in Chinese and “sun” in English; 7\dot{7} is equivalent to Radical [symbol] in Chinese and “moon” in English;
7\dot{8} is equivalent to Radical [symbol] in Chinese and “sunset, night” in English; 7\dot{9} is equivalent to Radicals [symbol] in Chinese and “light, electricity” in English;
8\dot{0} is equivalent to Radical [symbol] in Chinese and “fire” in English; 8\dot{1} is equivalent to Radical [symbol] in Chinese and “gas” in English;
8\dot{2} is equivalent to Radical [symbol] in Chinese and “wind” in English; 8\dot{3} is equivalent to Radical [symbol] in Chinese and “rain” in English;
8\dot{4} is equivalent to Radical [symbol] in Chinese and “ice” in English; 8\dot{5} is equivalent to Radical [symbol] in Chinese and “jade (collectively known as jade)” in English;
8\dot{6} is equivalent to Radical [symbol] in Chinese and “stone” in English; 8\dot{7} is equivalent to Radical [symbol] in Chinese and “mountain” in English;
8\dot{8} is equivalent to Radical [symbol] in Chinese and “farmland” in English; 8\dot{9} is equivalent to Radical [symbol] in Chinese and “soil” in English;
9\dot{0} is equivalent to Radical [symbol] in Chinese and “mound” in English; 9\dot{1} is equivalent to Radical [symbol] in Chinese and “bamboo” in English;
9\dot{2} is equivalent to Radical [symbol] in Chinese and “slice” in English; 9\dot{3} is equivalent to Radicals [symbol] in Chinese and “colour” in English;
9\dot{4} is equivalent to Radicals [symbol] in Chinese and “cyan, red” in English; 9\dot{5} is equivalent to Radicals [symbol] in Chinese and “yellow, white” in English;
9\dot{6} is equivalent to Radical [symbol] in Chinese and “black” in English; 9\dot{7} is equivalent to Radical [symbol] in Chinese and “belongings” in English;
9\dot{8} is equivalent to Radical [symbol] in Chinese and “wadi” in English; 9\dot{9} is equivalent to Radical [symbol] in Chinese and “direction, flag” in English;

### \textcircled{3} Formal Symbol

A formal symbol is the shortened title of a formal-type symbol. In a language, formal symbols are added to avoid repetition of single word characters and should be omitted if possible.

The formal symbols comprise of ten categories (0-9). One word can have 1-4 formal symbols as needed or be provided without any formal symbol; The formal symbols refer to the classification of basic letters or stroke forms used for various language, which basically reflects the letter and stroke form orders of different language; The following table shows 1) Latin aplhabet, 2) Arabic alphabet, 3) Slavic alphabet used by many countries as well as 4) Assamese alphabet, 5) Kannada alphabet, 6) Ethiopian alphabet, 7) Oriya alphabet, 8) Korean alphabet, 9) Sanskrit alphabet, 10) Georgian alphabet, 11) Gujarati alphabet, 12) Chinese stroke form/pinyin alphabet, 13) Cambodian alphabet, 14) Kanarese alphabet, 15) Laotian alphabetl6) Maldivian alphabet, 17) Malayalam alphabet, 18) Manchu/Sibe alphabet, 19) Manipuri alphabet, 20) Mongolian alphabet, 21) Bengali alphabet, 22) Burmese alphabet, 23) Panjabi alphabet, 24) Japanese alphabet, 25) Sinhalese alphabet, 26) Telugu alphabet, 27) Tamil alphabet, 28) Thai alphabet, 29) Hebrew alphabet, 30) Greek alphabet, 31) Armenian alphabet 32) Hindi alphabet, 33) Tibetan alphabet, 34) Javanese alphabet and other unique alphabet or stroke forms used by a country or nation; The letters of each language are arranged on the ten numeric keys (0-9) of the numeric keyboard to achieve inputting various letters and language through the numeric keyboard.

Formal symbol table of the digitized new language:

| Formal | |
|---|---|
| symbol | The basic letters or stroke forms used for various language worldwide |
| 0 | [symbol] [symbol] [symbol] |
| | [symbol] [symbol] |
| | [symbol] [symbol] [symbol] |
| | [symbol] [symbol] [symbol] |
| | [symbol] [symbol] |
| | [symbol] |
| 1 | [symbol] [symbol] [symbol] |
| | [symbol] [symbol] |
| | [symbol] [symbol] |
| | [symbol] [symbol] |
| | [symbol] [symbol] |
| | [symbol] |
| 2 | [symbol] [symbol] [symbol] |
| | [symbol] [symbol] |
| | [symbol] [symbol] |
| | [symbol] [symbol] |
| | [symbol] [symbol] |
| | [symbol] |
| 3 | [symbol] [symbol] |
| | [symbol] [symbol] |
| | [symbol] [symbol] |
| | [symbol] [symbol] |
| | [symbol] [symbol] |
| | [symbol] |
| 4 | [symbol] [symbol] |
| | [symbol] [symbol] |
| | [symbol] [symbol] |
| | [symbol] [symbol] |
| | [symbol] [symbol] [symbol] |
| | [symbol] |
| 5 | [symbol] [symbol] |
| | [symbol] [symbol] [symbol] |
| | [symbol] [symbol] [symbol] |
| | [symbol] [symbol] [symbol] |
| | [symbol] [symbol] [symbol] |
| | [symbol] |
| 6 | [symbol] [symbol] [symbol] |
| | [symbol] [symbol] [symbol] |
| | [symbol] [symbol] |
| | [symbol] [symbol] |
| | [symbol] [symbol] |
| | [symbol] |
| 7 | [symbol] [symbol] |
| | [symbol] [symbol] |
| | [symbol] [symbol] |
| | [symbol] [symbol] [symbol] |
| | [symbol] [symbol] [symbol] |
| 8 | [symbol] [symbol] [symbol] |
| | [symbol] [symbol] |
| | [symbol] [symbol] |
| | [symbol] [symbol] |
| | [symbol] [symbol] [symbol] |
| | [symbol] |
| 9 | [symbol] [symbol] |
| | [symbol] [symbol] |
| | [symbol] [symbol] |
| | [symbol] [symbol] |
| | [symbol] [symbol] |
| | [symbol] |

For example:
Formal Symbol 1 contains c d (Latin alphabet), [symbol] (Arabic alphabet), [symbol] (Slavic alphabet), [symbol] (Assamese alphabet), [symbol] (Kannada alphabet), [symbol] (Ethiopian alphabet), [symbol] (Oriya alphabet), [symbol] (Korean alphabet), [symbol] (Sanskrit alphabet), of [symbol] (Georgian alphabet), [symbol] (Gujarati alphabet), [symbol] (Chinese stroke form/pinyin alphabet), [symbol] (Cambodian alphabet), [symbol] (Kanarese alphabet), [symbol] (Laotian alphabet), [symbol] (Maldivian alphabet), [symbol] (Malayalam alphabet), [symbol] (Manchu/Sibe alphabet), [symbol] (Manipuri alphabet), [symbol] (Mongolian alphabet), [symbol] (Bengali alphabet), [symbol] (Burmese alphabet), [symbol] (Panjabi alphabet), [symbol] (Japanese alphabet), [symbol] (Sinhalese alphabet), [symbol] (Telugu alphabet), [symbol] (Tamil alphabet), [symbol] (Thai alphabet), [symbol] (Hebrew alphabet), γδε (Greek alphabet), [symbol] (Armenian alphabet), [symbol] (Hindi alphabet), [symbol] (Tibetan alphabet), [symbol] (Javanese alphabet) and so on.

### \textcircled{4} Difference Between Characters and Numbers

The ten Arabic numbers (0-9) involve both character and number meanings in the digitized new language, namely a character and the corresponding number are represented in the same form; When only one Arabic number is used, it refers to both a word and a number with the same meaning; When 2˜6 Arabic numbers are used, the difference between the characters and numbers is that adding the number identifier of “⋅” before an Arabic number string represents a number rather than a character; When two or more consecutive Arabic numbers represent a number, the number identifier “⋅” should be added at the beginning and end; Characters do not have any symbols, so those with symbols represent numbers, regardless of being at the beginning, in the middle or at the end. The numbers can be pronounced one by one or used in combination with “ten-billion 05, a-hundred-million 95, million 00, 10-thousand 90, thousand 62, hundred 01 and ten 75, etc.” e.g.: ⋅2021 is pronounced [lei be lei [symbol] ] or [lei nei be lei to [symbol] ].

### \textcircled{5} Simplification and Ligature of Characters

Although the ten Arabic numbers 0-9 are widely used in the world and are the most popular word-formation symbols, they still need to be simplified, because: 1) some require two strokes to write down, such as 4, 5 and 9; 2) Although some are can be write down with one stroke, the lines are too curved, such as 0, 2, 3, 6 and 8; 3) It is difficult to ligature two characters and the writing is not concise and quick enough.

Therefore, the simplification of characters 0, 1, 2, 3, 4, 5, 6, 7, 8 and 9 is also necessary. In addition to 1 with a hook [symbol] at the end stroke and 7 with a deformed form as [symbol] , other characters are truncated with the representative parts left to make the writing concise and quick. For example, [symbol] which can be written down with just one simple stroke.

Detailed simplification and ligature of characters:

| Simplification | 0 [symbol] | 1 [symbol] | 2 [symbol] | 3 [symbol] | 4 [symbol] | 5 [symbol] | 6 [symbol] | 7 [symbol] | 8 [symbol] | 9 [symbol] |
|---|---|---|---|---|---|---|---|---|---|---|
| 0 [symbol] | 00 [symbol] | 01 [symbol] | 02 [symbol] | 03 [symbol] | 04 [symbol] | 05 [symbol] | 06 [symbol] | 07 [symbol] | 08 [symbol] | 09 [symbol] |
| 1 [symbol] | 10 [symbol] | 11 [symbol] | 12 [symbol] | 13 [symbol] | 14 [symbol] | 15 [symbol] | 16 [symbol] | 17 [symbol] | 18 [symbol] | 19 [symbol] |
| 2 [symbol] | 20 [symbol] | 21 [symbol] | 22 [symbol] | 23 [symbol] | 24 [symbol] | 25 [symbol] | 26 [symbol] | 27 [symbol] | 28 [symbol] | 29 [symbol] |
| 3 [symbol] | 30 [symbol] | 31 [symbol] | 32 [symbol] | 33 [symbol] | 34 [symbol] | 35 [symbol] | 36 [symbol] | 37 [symbol] | 38 [symbol] | 39 [symbol] |
| 4 [symbol] | 40 [symbol] | 41 [symbol] | 42 [symbol] | 43 [symbol] | 44 [symbol] | 45 [symbol] | 46 [symbol] | 47 [symbol] | 48 [symbol] | 49 [symbol] |
| 5 [symbol] | 50 [symbol] | 51 [symbol] | 52 [symbol] | 53 [symbol] | 54 [symbol] | 55 [symbol] | 56 [symbol] | 57 [symbol] | 58 [symbol] | 59 [symbol] |
| 6 [symbol] | 60 [symbol] | 61 [symbol] | 62 [symbol] | 63 [symbol] | 64 [symbol] | 65 [symbol] | 66 [symbol] | 67 [symbol] | 68 [symbol] | 69 [symbol] |
| 7 [symbol] | 70 [symbol] | 71 [symbol] | 72 [symbol] | 73 [symbol] | 74 [symbol] | 75 [symbol] | 76 [symbol] | 77 [symbol] | 78 [symbol] | 79 [symbol] |
| 8 [symbol] | 80 [symbol] | 81 [symbol] | 82 [symbol] | 83 [symbol] | 84 [symbol] | 85 [symbol] | 86 [symbol] | 87 [symbol] | 88 [symbol] | 89 [symbol] |
| 9 [symbol] | 90 [symbol] | 91 [symbol] | 92 [symbol] | 93 [symbol] | 94 [symbol] | 95 [symbol] | 96 [symbol] | 97 [symbol] | 98 [symbol] | 99 [symbol] |

After the characters are simplified, for 2 characters, they can be ligatured from up to down; for 3 characters, 1 and 2 can be ligatured from up to down, while 3 can be written separately, for 4 characters, 1 and 2 as well as 3 and 4 can be ligatured from up to down; for 5 characters, 1 and 2 as well as 3 and 4 can be ligatured from up to down, 5 can be written separately; for 6 characters, 1 and 2, 3 and 4 as well as 5 and 6 can be ligatured from up to down; The ligatured characters will also be used as shorthand symbols for various language. For example, the ligature [symbol] of 010 (New Assamese) [symbol] Assamese” (Assamese).

### 2) Formation Method of Words and Phrases of the Digitized New Language

The formation method of the digitized new language includes words and phrases. Each word and phrase can have at most 5 characters. Any word or phrase in the same language is unique and will not repeat.

### \textcircled{1} Word-Formation Method

The “word” in the present invention refers to a single word or word. Words are divided into three parts, namely phonetic, semantic and formal parts, and each part represents a different meaning. The formation of a word involves the following four items:

When a word only involves “phonetic symbol”, it can have 1˜2 characters, e.g.: \dot{3} represents the plural (interpersonal language);

When the word involves the combination of “semantic symbol +phonetic symbol”, it can have 2˜4 characters, e.g.: 0\dot{2}10 (New Russian) refers to [symbol] Women” (Russian);

When the word involves the combination of “formal symbol +phonetic symbol”, it can have 2˜5 characters;

When the word involves the combination of “semantic symbol +formal symbol +phonetic symbol”, it can have 3˜5 characters.

The number of word characters of the digitized new language is relatively less. Phrases, sentences and texts should be formed by words, phrases and sentences respectively if possible.

### \textcircled{2} Phrase-Formation Method

The “phrase” in the present invention refers to a collocation or phrase. Phrases are formed by two or more words and can help to reduce the number of characters and speed up the writing. Their identifier is “ ”, The phrase vowels are pronounced in a falling tone and then a rising tone [\check{ }], 0̅[bě], 1̅[ [symbol] ], 2̅[lěi], 3̅[m\check{i}], 4̅[f\check{a}], 5̅[s\check{o}], 6̅[n\check{a}i], 7̅[t\check{i}n], 8̅[k [symbol] n], 9̅[p\check{u}].

The formation of a phase involves the following three items:

For a phrase formed by two words: the first word uses the first 2 characters, while the second uses the last 3 characters, namely 2+3, and the identifier “ ” shall be added above the second character, e.g.: 4 0̅400 (New Albanian) refers to “më fal sorry” (Albanian);

For a phrase formed by three words: the first word uses the first 1 character, the second uses the first 2 characters and the last uses the last 2 characters, namely 1+2+2, and the identifier “ ” shall be added above the third character, e.g.: 340̅19 (New German) refers to “ich liebe dich I love you” (German);

For a phrase formed by four or more words: the first, second and third words use the first 1 character, while the last uses the last 2 characters, namely 1+1+1+2, and the identifier “ ” shall be added above the fourth character, e.g.: 804 3̅1 (New Chinese) refers to “digitized new language” (Chinese);

Regardless of the item, the phrase always retains the phonetic symbol of the last syllable of the last word.

### \textcircled{3} Arrangement of Words and Phrases

Words and phrases are arranged linearly from left to right in single lines. Three to five characters can also be arranged in two lines. Three characters are arranged with 1 on the left, top and bottom, respectively. Four characters are arranged with 2 on the top and bottom, respectively. Five characters are arranged with 2 on the top and bottom, respectively and 1 on the right. Six characters are arranged with 3 on the top and bottom, respectively. For example, [symbol] and refer to [symbol] and 23456, respectively.

The space occupied by the two lines is relatively small. Reducing the sight length can help to improve the unit reading volume, but it should be supported by the word bank, just like the arrangement of Chinese and Korean square characters.

### \textcircled{4} Ellipsis, Abbreviation and Font Size of Words and Phrases

(1) Omission of repeated characters: Regardless of words or phrases, if a character will be repeated, ellipses [symbol] can be used after it to avoid repetition, which indicate that two, three, four or five characters are the same, respectively. When a character will be repeated six times, the ellipsis \tilde{ } can be used after it. Omission vowels are pronounced in a rising tone [\acute{ }], 0 [bé], 1 [ [symbol] ], 2 [léi], 3 [mí], 4 [fá], 5 [só], 6 [nái], 7 [tín], 8 [k [symbol] n], 9 [pú]. For example, 22 can be shortened as 2\acute{ } or [symbol] pronounced [léi]; 222 can be shortened as 2\check{ } or [symbol] pronounced [l [symbol] lei]; 22222 can be shortened as 2\grave{ } or [symbol] pronounced [léi léi]; 22222 can be shortened as 2\hat{ } or [symbol] pronounced [l [symbol] lei]; 222222 can be shortened as 2\tilde{ } or [symbol] pronounced [l [symbol] lei l [symbol] lei].
(2) Abbreviation refers to using only one or two characters from a word or phrase comprising of 3˜5 characters. The identifier “ ” of abbreviation is the same as that used for phrases, the difference is that it is added above the first character. Abbreviation vowels are pronounced in a falling tone and then a rising tone [\check{ }], 0̅[bě], 1̅[ [symbol] ], 2̅[lěi], 3̅[m\check{i}], 4̅[f\check{a}], 5̅[s\check{0}], 6̅[n\check{a}i], 7̅[t\check{i}n], 8̅[k [symbol] n], 9̅[p\check{u}]. For example, 1̅5 (pronounced [d\check{0}] in the past continuous tense, which is an abbreviation for past tense 10 and continuous tense 53).
(3) At most 3 big/small font sizes for characters can be used. The font size for the first character shall be the same as that used throughout the text, and the small font size shall be used for the following one or two characters. big/small font sizes shall be pronounced in a falling tone [\grave{ }], 0 [bè], 1 [ [symbol] ], 2 [lèi], 3 [mì], 4 [fà], 5 [s\grave{0}], 6 [nài], 7 [t ìn], 8 [k [symbol] n], 9 [pù]. For example, Alt: When the font size of “A” is 12 pt throughout the entire text, while “It”, 10.5 pt, which means that Alt is corresponding to 048 and pronounced [b [symbol] f [symbol] n].

### 3) Syllables of the Digitized New Language

For the digitized new language, a character means a syllable. In order to reduce the number of syllables, each word or phrase can only be pronounced with a maximum of two syllables.

### \textcircled{1} Monosyllable: Including Single-Character, Double-Character and Triple-Character.

Single-character: namely a word or a number, both have the same form and pronunciation, 0 [be] and 1 [ [symbol] ], 2 [lei], 3 [mi], 4 [fa], 5 [so], 6 [nai], 7 [tin], 8 [ [symbol] n] and 9 [pu]; Single-character means a zero-consonant vowel, namely there is no any consonant before the vowel. The identifier “\dot{ }” for the zero consonant vowel is the same as that used for semantic symbols, the difference is that it is added above the last character representing a phonetic symbol. The zero-consonant vowels are pronounced with a long sound [:], 0 [be:], and 1 [ [symbol] :], 2 [lei:], 3 [mi:], 4 [fa:], 5 [so:], 6 [nai:], 7 [ti: n], 8 [k [symbol] :n] and 9 [pu:].

Double-character: namely “consonant +vowel”, with the first character is a consonant and the second character, a vowel. The consonant and vowel are pronounced together as follows:

| | Second character | | | | | | | | | |
|---|---|---|---|---|---|---|---|---|---|---|
| First | 0 | 1 | 2 | 3 | 4 | 5 | 6 | 7 | 8 | 9 |
| character | [be] | [d [symbol] ] | [lei] | [mi] | [fa] | [so] | [nai] | [tin] | [k [symbol] n] | [pu] |
| 0 [be] | [bé] | [b [symbol] ] | [bei] | [bi] | [ba] | [bo] | [bai] | [bin] | [b [symbol] n] | [bu] |
| 1 [d [symbol] ] | [de] | [d [symbol] ] | [dei] | [di] | [da] | [do] | [dai] | [din] | [d [symbol] n] | [du] |
| 2 [lei] | [le] | [l [symbol] ] | [léi] | [li] | [la] | [lo] | [lai] | [lin] | [l [symbol] n] | [lu] |
| 3 [mi] | [me] | [m [symbol] ] | [mei] | [m\acute{í}] | [ma] | [mo] | [mai] | [min] | [m [symbol] n] | [mu] |
| 4 [fa] | [fe] | [f [symbol] ] | [fei] | [fi] | [fá] | [fo] | [fai] | [fin] | [f [symbol] n] | [fu] |
| 5 [so] | [se] | [s [symbol] ] | [sei] | [si] | [sa] | [só] | [sai] | [sin] | [s [symbol] n] | [su] |
| 6 [nai] | [ne] | [n [symbol] ] | [nei] | [ni] | [na] | [no] | [nái] | [nin] | [n [symbol] n] | [nu] |
| 7 [tin] | [te] | [t [symbol] ] | [tei] | [ti] | [ta] | [to] | [tai] | [tín] | [t [symbol] n] | [tu] |
| 8 [k [symbol] n] | [ke] | [k [symbol] ] | [kei] | [ki] | [ka] | [ko] | [kai] | [kin] | [k [symbol] n] | [ku] |
| 9 [pu] | [pe] | [p [symbol] ] | [pei] | [pi] | [pa] | [po] | [pai] | [pin] | [p [symbol] n] | [pú] |

Triple-character: The vowel of the first character is changed to an elision [ [symbol] ], and the pronunciation for the last two characters is the same as that for double-characters, namely “consonant [symbol] (ellipsis) +consonant +vowel”. For example, 012 [b [symbol] dei], namely [bdei], 013 [b [symbol] di], namely [gdi]; The first character is pronounced [ [symbol] :] when having a semantic symbol, for example, \dot{1}23 [d [symbol] :li], \dot{4}56[f [symbol] :sai].

### \textcircled{2} Didisyllable: Including Quadruple Character and Quintuple-Characters.

Quadruple-character: Two characters form one syllable. The pronunciation method is the same as that for double-characters;

Quintuple-character: The first two characters form one syllable, the pronunciation is the same as that for double-characters; The last three characters form one syllable, the pronunciation is the same as that for triple-characters;

For six characters, every three characters form one syllable, and the pronunciation the same as that for triple-characters.

### 2. New Digitized Braille

Brailles are communication tools for visually impaired individuals and important means for participating in social life and receiving education. It is necessary to connect the communication tools used by visually impaired individuals with those used by normal ones to facilitate the communication and promote the mutual trust.

For the new digitized Braille, the blind symbols can be used to replace the ten characters 0˜9 of the digitized new language. The new digitized Braille, also known as new Braille, is characterized in that the blind symbols can be used to replace the ten characters 0˜9 of the digitized new language, which corresponds to the new language used by normal persons. The Braille of a country should be consistent with the language used by normal persons in the country. For the new digitized Braille, at most six dots are arranged for each square, among which three dots take a column, and six dots take two columns for touch-reading and writing from the left to the right and from the top to the bottom. A square refers to a complete independent unit, a single word (word), phrase, punctuation mark and letter, etc; Convex and concave dots are set, including their corresponding circular, semi-circular, square and semi-square dots;
1) Convex dots represent ten types of characters that protrude out of the surface. The circular dot [symbol] represents Convex 0. The semi-circular dots are set at four positions, namely the top [symbol] , bottom [symbol] , left [symbol] and right [symbol] representing Convexes 2, 4, 6 and 8, respectively; The square dot [symbol] represents Convex 1. The half-square dots are set at four positions, namely the top [symbol] , bottom [symbol] , left [symbol] and right [symbol] representing Convexes 3, 5, 7 and 9, respectively.

When representing a word, the corresponding convex dot blind symbols can appear directly; When representing a semantic symbol, each convex dot blind symbol will be added with a concave dot on the top, including: [symbol] Convex \dot{0}, [symbol] Convex \dot{1}, [symbol] Conve\dot{2}, [symbol] Convex \dot{3}, [symbol] Convex \dot{4}, [symbol] : Convex \dot{5}, [symbol] : Convex \dot{6}, [symbol] Convex \dot{7}, [symbol] Convex \dot{8}, [symbol] Convex \dot{9}; When representing a phrase, each convex dot blind symbol will be added with a concave dash on the top, including: [symbol] Convex 0̅, [symbol] Convex 1̅, [symbol] Convex 2̅, [symbol] Convex 3̅, [symbol] Convex 4̅, [symbol] Convex 5̅, [symbol] Convex 6̅, [symbol] Convex 7̅, [symbol] Convex 8̅, [symbol] Convex 9̅.
2) Concave dots (yellow below) represent ten types of Braille symbols that concave into the surface. The circular dot [symbol] represents Concave 0. The semi-circular dots are set at four positions, namely the top [symbol] , bottom [symbol] , left [symbol] and right [symbol] representing Concaves 2, 4, 6 and 8, respectively; The square dot [symbol] represents Concave 1. The half-square dots are set at four positions, namely the top [symbol] , bottom [symbol] , left [symbol] and right [symbol] , representing Convexes 3, 5, 7 and 9, respectively;

When representing types, the concave blind symbols will appear first, followed by different contents after different concave dots as follows:

The appeared Concave 0, namely Dot [symbol] indicates that an Arabic number will appear after it, e.g.: Number 1 is [symbol] (vertically arranged);

The appeared Concave 1, namely Dot [symbol] indicates that a punctuation mark will appear after it;

The appeared Concave 2, namely Dot [symbol] indicates that a mathematical symbol will appear after it;

The appeared Concave 3, namely Dot [symbol] indicates that a commercial symbol will appear after it;

The appeared Concave 4, namely Dot [symbol] indicates that a Latin letter will appear after it; One or two blind symbols represent a letter, e.g.: the Latin letter a is [symbol] (vertically arranged), b is [symbol] (vertically arranged);

The appeared Concave 5, namely Dot [symbol] indicates that an Arabic letter will appear after it; One or two blind symbols represent a letter;

The appeared Concave 6, namely Dot [symbol] indicates that a Slavic letter will appear after it; One or two blind symbols represent a letter;

The appeared Concave 7, namely Dot [symbol] indicates that a letter used separately by a country or nation will appear after it; One or two blind symbols represent a letter;

Concave 8 or 9, namely Dot [symbol] is set dependent on the language.

### 3. New Digitized Sign Language

Sign language are communication tools for deaf-mute individuals and important means for participating in social life and receiving education. It is necessary to connect the communication tools used by deaf-mute individuals with those used by normal ones to facilitate the communication and promote the mutual trust.

For the new digitized sign language, the signs can be used to replace the ten characters 0˜9 of the digitized new language. The new digitized sign language, also known as new sign language, is characterized in that the signs can be used to replace the ten characters 0˜9 of the digitized new language, which corresponds to the new language used by normal persons. The sign language of a country should be consistent with the language used by normal persons in the country.
1) The new digitized sign language uses five fingers of one hand to represent the ten characters (0˜9) of the digitized new language, among them the thumb represents 5, and the index finger, middle finger, ring finger and little finger each represent 1.

As shown in FIG. 11 of the Instruction, representation of Character 0: Forming a circle with the tip of the thumb and the other four fingers;

Representation of Character 1: Stretching out the index finger and folding the remaining fingers;

Representation of Character 2: Stretching out the index finger and middle finger and folding the remaining fingers;

Representation of Character 3: Stretching out the middle finger, ring finger and little finger and folding the remaining fingers;

Representation of Character 4: Stretching out the index finger, middle finger, ring finger and little finger and folding the remaining finger;

Representation of Character 5: Stretching out the thumb and folding the remaining fingers; Representation of Character 6: Stretching out the thumb and index finger to form an angle and folding the remaining fingers;

Representation of Character 7: Stretching out the thumb, index finger and middle finger to form an angle and folding the remaining fingers;

Representation of Character 8: Stretching out the thumb, middle finger, ring finger and little finger and folding the index finger;

Representation of Character 9: Stretching out the five fingers with the thumb and the remaining four fingers forming an angle;

Representation of an end: Making a fist.

When both hands are used, the representations can be speed up from the left hand to the right.
2) When representing words, signs can be used directly; When representing a semantic sign, place the index finger of the other hand vertically on one of the fingers representing a number as shown in FIG. 12-1 of the Instruction; When representing a phrase, place the index finger of the other hand horizontally on one of the fingers representing a number as shown in FIG. 12-2 of the Instruction;

When representing types, bend and place the index finger of the other hand on one tip of the fingers representing a number as shown in FIG. 12-3 of the Instmction. Placing on the fingers representing different numbers means different contents as follows:

Placing on the finger representing 0 means that an Arabic number will appear after it;

Placing on the finger representing 1 means that a punctuation mark will appear after it. As shown in FIG. 12-4 of the Instruction, it means a comma;

Placing on the finger representing 2 means that a mathematical symbol will appear after it;

Placing on the finger representing 3 means that a commercial symbol will appear after it;

Placing on the finger representing 4 means that a Latin letter will appear after it, and one or two signs represent a letter;

Placing on the finger representing 5 means that an Arabic letter will appear after it, and one or two signs represent a letter;

Placing on the finger representing 6 means that a Slavic letter will appear after it, and one or two signs represent a letter;

Placing on the finger representing 7 means that a letter used separately by a country or nation will appear after it, and one or two signs represent a letter;

The meaning of placing on the finger representing 8 or 9 is set dependent on the language.

When representing that two numbers are the same, the index finger tip of the other hand should tilt upward in the form of \acute{ }; When representing that three numbers are the same, the index finger of the other hand should bend in the form of \check{ } and be placed on that finger; When representing that four numbers are the same, the tip of the index finger of the other hand should tilt downward in the form of \grave{ }; When representing that five numbers are the same, the index finger of the other hand should bend in the form of \hat{ } and cover on that finger. FIG. 13 of the Instruction shows the representations for two ones, three ones, four ones and five ones.

### 4. Digitized New Current Language and its Corresponding Braille and Sign Language

The digitized new current language refers to that digitizedizing the current global language, wherein the letters and stroke forms of the current language are replaced by ten Arabic numbers 0˜9 used as characters, implementing the digitized new language in the current language. For example, 385 (New Finnish) refers to “heti, immediately” (Finnish).

In order to make a clear distinction between it and the current language, the word “new” should added before the language names, such as: New Arabic, New Korean, New Russian, New Chinese, New Latin, New Japanese, New Hebrew, New Greek, New Hindi, New English, etc.

### 1) Braille of the Digitized New Current Language

The Braille of the digitized new current language refers to that using blind symbols to represent the ten characters 0˜9 of the e digitized new current language, wherein the digitized characters of the current new language can be converted into those blind symbols used for the new digitized Braille, for example, the 65 (new Arabic, [symbol] of the new Arabic Braille refers to

[symbol]

### 2) Sign Language of the Digitized New Current Language

The sign language of the digitized new current language refers to that using signs to represent the ten characters 0˜9 of the digitized new current language, wherein the digitized characters of the new current language can be converted into signs used in the new digitized sign language.

The name of a language's new braille or sign language is to add the “braille” or “sign language” after the digitized language, namely the “new XX language Braille or sign language”, e.g.: New Arabic Braille or Sign language, New Persian Braille or Sign language, New Japanese Braille or Sign language, New Italian Braille or Sign language, etc. For example, FIG. 14 of the Instruction shows the sign of 65 [symbol] in the new Arabic.

### 5. Interpersonal Language and its Braille and Sign Language

The interpersonal language is the shortened title of interpersonal communication language. It is a new interpersonal communication language created according to the digitized new language and a digitized Interlingua for people using different language and living in different countries, regions and nations to communicate without barriers. It is an international all-purpose language and is characterized in that:

### I) Nature

The interpersonal language is an international digitized all-purpose language created by using ten Arabic numbers 0˜9 as word-formation symbols and rooting in the current human language.

### II) Functional Words

According to the syntactic functions, the words of the interpersonal language are: The subject words including nouns, pronouns and numerals; The predicate including verbs; Object words including nouns, pronouns and numerals; Adjunct words including adjectives (as attributes) and adverbs (as adverbials); Conjunctive words including prepositions and conjunctions; Independent words including interjections and onomatopoeia; Tense words including past/present/future/progressive/perfect tenses and other tense expressions.

Nouns, verbs, adjectives and adverbs should all remain in their original forms.

### III) Semantic Multi-Part-of-Speech Words

A word having different parts-of-speech at different positions of a sentence, which involves semantic multi-part-of-speech and therefore it is unnecessary to coin related words. Such words are: nouns with verb and adjective parts-of-speech, pronouns with possessive relationships; verbs with transitive, intransitive and noun parts-of-speech, adjectives with adverb part-of-speech and adverb with adjective part-of-speech, for example, “Snow” is a noun when used for “snowing” and an adjective when used for “snowscape”; “I” is a pronoun when used for “myself” and means “my” when used for “my brother”, indicating a possessive relationship.

IV) The use of \dot{3}represents a plural, for example, “we” is expressed as \dot{1}\dot{3}.

### V) Basic Sentence Patterns

(Attribute) subject+(adverbial) predicate (transitive verb)+(attribute) (indirect object)+(attribute) direct object

(Attribute) subject+(adverbial) predicate (intransitive verb)

### VI) Tenses

Tenses are expressed using tense words or adverbials of time: Past tense—10, present tense—06 (usually not used), future tense—50, progressive tense—53 and perfect tense—16.

### VII) Syntactical Structures

Before the verb of an affirmative sentence, a negative sentence, passive sentence (transposition of the subject and object) and interrogative sentence can be formed by adding a negative meaning (80), passive meaning (76) and questioning meaning (78, at the end of the sentence), respectively;

Subjunctive sentences, imperative sentences and other sentences can be expressed with the relevant words and phrases.

### VIII) Puntuation Marks

The caesura sign, dash, full stop, ellipsis and hyphen or alternate character in interpersonal language are [symbol] ”, “—”, “○ ”, “. . . ” and “˜”, respectively.

### 1) Interpersonal Language Braille

The interpersonal language Braille refers to that converting the characters of the interpersonal language into blind symbols, wherein the characters of the interpersonal language can be converted into blind symbols of the new digitized Braille, for example, the 40 (persons) of the interpersonal language Braille refers to [symbol] (vertically arranged);

### 2) Interpersonal Sign Language

The interpersonal sign language refers to that converting the characters of the interpersonal language into signs of deaf-mute individuals, wherein the characters of the interpersonal language can be converted into signs of deaf-mute individuals, for example, the 40 (persons) in the interpersonal sign language as shown in FIG. 15 of the Instruction.

The Braille and sign language created based on the interpersonal language will provide channels for the communication among visually impaired and deaf-mute individuals in various countries and races and can also be integrated into the normal interpersonal communication regardless of countries and races.

### 6. Interstellar Language

The interstellar language is the shortened title of interstellar communication language, which is a graphical language for interpersonal language and characterized in that the interpersonal language is an interstellar language, and graphics are provided based on the phonetic, semantic and formal designs of the interpersonal language, making it possible to communicate with extraterrestrial beings on other planets thanks to the intuitive and readable design.

### 7. Input Method of Digitized New Language

The input method does not change regardless of whether it is completed through text input or listening/speaking input, wherein the input is completed based on the characters of words or phrases, namely one character can be input by pressing a key once. The number of characters is equivalent to the times to be pressed on the keys, which can be ended by pressing the space bar; For square words arranged in two lines, each word or phrase will end naturally after the keys are pressed 5 times. The input of those words by pressing the keys less than 5 times can end by pressing the space bar; Six characters can be input by pressing the key combination of . and =, which should be pressed again for an end; When inputting a semantic symbol within \dot{0}˜\dot{9} and a phrase within 0̅˜9̅ on the numeric keyboard, the combination of the corresponding key and another key should be pressed, for example, the 0\dot{2}56 (new Hausa) refers to “kishi jealousy” (Hausa), where the input \dot{2} refers to 2 plus 0, and the remaining 0, 5, 6 can be entered directly by clicking the corresponding keys.

The digitized new language will make the development of software and hardware for handwriting and speech input more mature, achieving a more accurate recognition.

### 8. Input Tool of Digitized New Language

An input tool for the digitized new language, wherein it includes a keyboard with a mouse, a numeric keyboard with a mouse, a mouse with a numeric keyboard and a new Braille mobile phone keyboard.

### 1) Keyboard With a Mouse

A keyboard with a mouse provided in the present invention, wherein both hands can easily operate the mouse without leaving the keyboard, and keyboard can be operated without leaving the mouse; The keyboard includes click keys and key combinations;

The click keys are used for achieving the keyboard's functions such as Insert/Rewrite, Delete, Start-Of-Line, End-Of-Line, Page Up, Page Down, Screenshot, Control, Select, Shift, Space, Window, Cursor Left/Right/Up/Down, Enter, Backspace, Function Combination, Pause, Table, Exit and Functions 1-12; After clicking on the functional key combination, the numeric keyboard can be started and the operations of the ten numbers 0˜9 and six operation symbols namely /, *, +, −, . and =can be completed;

For the key combinations, the “Shift ←, → and ↓” refers to Num Lock, Caps Lock and Screen Lock, respectively. The “Shift plus symbol key” refers to inputting the shift symbol; When combined with other keys, the Control, Select, Window and Function Combination of the key combinations will achieve different functions;

[symbol] Multimedia functions include Browser, Email [symbol] , Favorites [symbol] , Multimedia Player [symbol] , Mute [symbol] , Stop [symbol] , Previous [symbol] , Next [symbol] , Play/Pause [symbol] , Calculator [symbol] , Volume − [symbol] and Volume + [symbol] ;

When inputting the current language, the character keys and symbol keys can be changed to the letters and symbols of the required language to meet the keyboard input requirements for various language;

Below the keyboard are the mouse wheel, left/right keys, control cursor device, as well as three key indicators: Num Lock, Caps Lock and Screen Lock. The mouse can be easily operated by simply moving down the left or right thumb, and the cursor can be controlled by moving down the right thumb;

The screen can be set through the top of the keyboard to display the input content; The relevant purposes can be added depending on the industry.

### 2) Numeric Keyboard With a Mouse

A numeric keyboard with a mouse provided in the present invention, wherein the functions of the numeric keyboard and the mouse can be combined skillfully, and the operations can be completed with one or both hands. The numeric keyboard includes click keys, long-press keys and key combinations.

The click keys are used for inputting the ten characters 0˜9 and mathematical operation symbols /, *, ., +, − and = and achieving the keyboard functions such as Space, Exit, Enter, Page Down, Page Up, Num Lock, Caps Lock, Screen Lock, Cursor Left/Right/Up/Down, Screenshot and Pause;

The long-press keys are used for achieving the keyboard functions such as Start-Of-Line, End-Of-Line, Insert/Rewrite, Table, Delete, Backspace, Shift, Control, Select, Window and Function Combination;

The key combinations include /, *, =, ., −, +, Enter. When combined with other keys, they can achieve different functions;

Multimedia functions include Browser [symbol] , Email [symbol] , Favorites [symbol] , Multimedia Player [symbol] , Mute [symbol] , Stop [symbol] , Previous [symbol] , Next [symbol] , Play/Pause [symbol] , Calculator [symbol] , Volume − [symbol] and Volume + [symbol] ;

When inputting the current language, the characters and symbols can be input using the ten numeric keys 0˜9 according to the required language to meet the keyboard input requirements for various language, for example, when inputting Japanese, the Keys 0 and 1 can be used for inputting [symbol] and [symbol] , respectively, . . . ;

Below the keyboard are the mouse wheel, left/right keys, cursor control device, as well as three key indicators: Num Lock, Caps Lock and Screen Lock. The mouse and cursor can be easily operated by simply moving down the right thumb;

The screen can be set through the top of the keyboard to display the input content; The relevant purposes can be added depending on the industry; The numeric keyboard can be used as an operation keyboard for small and micro products, for example, mobile phones and laptops, etc.

### 3) Mouse With a Numeric Keyboard

A mouse with a numeric keyboard provided in the present invention, wherein the functions of the mouse and the numeric keyboard can be combined skillfully, with the mouse on the top and the numeric keyboard on the bottom. The operations can be completed with one or both hands;

The mouse on the top includes a mouse wheel, left/right keys and a cursor control device for controlling the cursor by moving the mouse. The cursor can also be controlled by shaking the cursor control device on the upper left without moving the mouse. The cursor control device can be either a component with an optical lens on both upper and lower parts, respectively, or a combination of two optical lens components;

The numeric keyboard on the bottom includes click keys, long-press keys and key combinations.

The click keys involve ten character keys 0˜9 and mathematical operation symbol keys /, *, ., +, − and =, as well as Space and Enter;

The long-press keys include Start-Of-Line, End-Of-Line, Page Up, Page Down, Insert/Rewrite, Table, Cursor Left/Right/Up/Down, Delete, Backspace, Shift, Control, Select, Window and Function Combination;

The key combinations include /, *, =, ., −, +, Enter. When combined with other keys, they can achieve different functions;

Multimedia functions include Browser [symbol] , Email [symbol] , Favorites [symbol] , Multimedia Player [symbol] , Mute [symbol] , Stop [symbol] , Previous [symbol] , Next [symbol] , Play/Pause [symbol] , Calculator [symbol] , Volume − [symbol] and Volume + [symbol] ;

When inputting the current language, the characters and symbols can be input using the ten numeric keys 0˜9 according to the required language to meet the keyboard input requirements for various language;

The three indicators on the numeric keyboard, from left to right, are used for the Num Lock, Caps Lock and Screen Lock.

The relevant purposes can be added depending on the industry; The numeric keyboard can also be used as an operation keyboard for small and micro products, for example, mobile phones and laptops, etc.

### 4) Relevant Functions of the Numeric Keyboard Involved in the Numeric Keyboard With a Mouse and the Mouse With a Numeric Keyboard.

\textcircled{1} When the Num Lock indicator is on (the Num Lock indicator is on automatically after the computer is started), the following functions will be achieved:
(1) Input characters

| | | Input | | Input | |
|---|---|---|---|---|---|
| Input | Key | semantic | Key | phrase | Key |
| character | operation | sym. | operation | character | operation |
| 0 | Click 0 | \dot{⁰} | 0 plus 1 | ⁰̅ | 0 plus 2 |
| 1 | Click 1 | \dot{¹} | 1 plus 0 | ¹̅ | 1 plus 2 |
| 2 | Click 2 | \dot{²} | 2 plus 0 | ²̅ | 2 plus 1 |
| 3 | Click 3 | \dot{³} | 3 plus 0 | ³̅ | 3 plus 1 |
| 4 | Click 4 | \dot{⁴} | 4 plus 5 | ⁴̅ | 4 plus 6 |
| 5 | Click 5 | \dot{⁵} | 5 plus 4 | ⁵̅ | 5 plus 6 |
| 6 | Click 6 | \dot{⁶} | 6 plus 4 | ⁶̅ | 6 plus 5 |
| 7 | Click 7 | \dot{⁷} | 7 plus 8 | ⁷̅ | 7 plus 9 |
| 8 | Click 8 | \dot{⁸} | 8 plus 7 | ⁸̅ | 8 plus 9 |
| 9 | Click 9 | \dot{⁹} | 9 plus 7 | ⁹̅ | 9 plus 8 |

(2) Input numbers

Key combination/plus 0, 1, 2, 3, 4, 5, 6, 7, 8 and 9 refer to inputting the numbers ⋅0, ⋅1, ⋅2, ⋅3, ⋅4, ⋅5, ⋅6, ⋅7, ⋅8 and ⋅9 respectively; After long pressing +, the numbers can be input directly by clicking the numeric keys.
(3) Input symbols
Key combination Enter plus 0, 1, 2, 3, 4, 5, 6, 7, 8, 9, /, *, =, ., − and +refer to inputting the shift symbols of the corresponding keys;
Key combination/plus*input sysmbol*,/plus Enter refers to inputting the shift symbol of Enter.

(4) Combination functions of Key Combination =

| 12 | Keyboard |
|---|---|
| functions | operation |
| Function 1 | = plus 1 |
| Function 2 | = plus 2 |
| Function 3 | = plus 3 |
| Function 4 | = plus 4 |
| Function 5 | = plus 5 |
| Function 6 | = plus 6 |
| Function 7 | = plus 7 |
| Function 8 | = plus 8 |
| Function 9 | = plus 9 |
| Function 10 | = plus 0 |
| Function 11 | = plus * |
| Function 12 | = plus / |

(5) Combination functions of Key Combination .:

| Multimedia | Keyboard |
|---|---|
| function | operation |
| Web Page | . plus 1 |
| Email | . plus 2 |
| Favorites | . plus 3 |
| Multimedia | . plus 4 |
| Player | |
| Mute | . plus 5 |
| Previous | . plus 6 |
| Next | . plus 7 |
| Play/Pause | . plus 8 |
| Stop | . plus 9 |
| Calculator | . plus 0 |
| Volume − | . plus / |
| Volume + | . plus * |

(6) Combination functions of Key Combination −:

| Related | Keyboard |
|---|---|
| function | operation |
| Num Lock Switch | - plus 0 |
| Caps Lock Switch | - plus 1 |
| Screen Lock | - plus 2 |
| Exit | - plus 3 |
| Pause | - plus 4 |
| Screenshot | - plus 5 |
| Deleting the | - plus 6 |
| selected item | |
| directly | |

(7) Combination functions of Key Combination +:

| Related function | Keyboard operation |
|---|---|
| Select All | + plus 0 |
| Bold | + plus 0 plus 1 |
| Copy | + plus 1 |
| Font Format | + plus 1 plus 2 |
| Center alignment | + plus 2 |
| Search | + plus 2 plus 0 |
| Position | + plus 2 plus 1 |
| Replace | + plus 3 |
| Italic | + plus 3 plus 0 |
| Double-End Alignment | + plus 3 plus 1 |
| Hyperlink | + plus 4 |
| Left Alignment | + plus 4 plus 0 |
| left Indent | + plus 4 plus 1 |
| New | + plus 5 |
| Open | + plus 5 plus 0 |
| Print | + plus 5 plus 1 |
| Cancel Paragraph Format | + plus 6 |
| Right Alignment | + plus 6 plus 0 |
| Save | + plus 7 |
| Cut | + plus 7 plus 4 |
| First Line Indent | + plus 8 |
| Underline | + plus 8 plus 4 |
| Cancel | + plus 8 plus 5 |
| Paste | + plus 9 |
| Close | + plus 9 plus 4 |
| Restore | + plus 9 plus 5 |
| Input Method Conversion | + plus Enter |
| Character/Number Switching | + plus = |
| SBC Case/DBC Case Conversion | + plus - |

(8) The combination functions of Key Combination * are pending;
   \textcircled{2} When the Num Lock indicator is off
(1) Input letters

According to the “formal symbol table of the digitized new language”, for the letter input of various current language, all letters of the desired language are arranged through the ten numeric keys 0˜9. The detailed method is as follows:

| Input of | |
|---|---|
| the 1^{st} letter | Input of the 2~8^{th} letters of this key |
| Click 0 | Input the 2~8^{th} letters through “0 plus |
| | 1, 2, 3, 4, 5, 6 and *”, respectively |
| Click 1 | Input the 2~8^{th} letters through “1 plus |
| | 0, 2, 3, 4, 5, 6 and *”, respectively |
| Click 2 | Input the 2~8^{th} letters through “2 plus |
| | 0, 1, 3, 4, 5, 6 and *”, respectively |
| Click 3 | Input the 2~8^{th} letters through “3 plus |
| | 0, 1, 2, 4, 5, 6 and *”, respectively |
| Click 4 | Input the 2~8^{th} letters through “4 plus |
| | 0, 1, 2, 3, 5, 6 and *”, respectively |
| Click 5 | Input the 2~8^{th} letters through “5 plus |
| | 0, 1, 2, 3, 4, 6 and *”, respectively |
| Click 6 | Input the 2~8^{th} letters through “6 plus |
| | 0, 1, 2, 3, 4, 5 and *”, respectively |
| Click 7 | Input the 2~8^{th} letters through “7 plus |
| | 4, 5, 6, *, 8, 9 and /”, respectively |
| Click 8 | Input the 2~8^{th} letters through “8 plus |
| | 4, 5, 6, *, 7, 9 and /”, respectively |
| Click 9 | Input the 2~8^{th} letters through “9 plus |
| | 4, 5, 6, *, 7, 8 and /”, respectively |

For example, when the Latin letters e, f and g are to be input through keys, just click “2” to input the letter e, “2 plus 0” to input the letter f, and “2 plus 1” to input the letter g; When the Caps Lock indicator is on, the capital letters E, F, and G can be input according to the above method.
(2) The combination functions of Key Combination /, *, =, ., −, + and Enter are pending.

### 5) New Braille Mobile Phone Keyboard

The new Braille keyboard includes ten blind symbols: [symbol] and [symbol] , representing ten dialing keys (0, 1, 2, 3, 4, 5, 6, 7, 8 and 9), respectively. * is used for dialing out. / is used for receiving incoming calls. Voice prompts are provided when pressing the keys and according to the various language such as interpersonal language.

The ten Arabic numbers 0˜9 are the most suitable for being used as the word-formation symbols of the digitized new language, because: 1) The ten Arabic numbers 0˜9 are international codes and universal symbols, while Latin/Arabic/Slavic letters and other letters or stroke forms are far away from being universal; 2) The ten Arabic numbers 0˜9 have the least word-formation symbols comparing current written language, and the word -formation components are much simpler than any other current language; 3) It is much easier to learn the ten word-formation symbols (0-9) than to master any letter or stroke form. Learning the ten Arabic numbers means grasping the word-formation symbols; 4) The ten Arabic numbers 0˜9 represent both mathematical numbers and language characters. A single-character word has the same form and pronunciation with those of the single digit representing a number; 5) The ten Arabic numbers 0˜9 unify the word-formation symbols of various human language, and the word forms of all language are the same, so it is much easier to understand and write any current language; 6) Various language composed of the ten characters 0˜9 are conducive to communication, translation and transformation among language, minimizing the barriers and costs caused by differences among language; 7) All language composed of the ten characters 0˜9 should be consistent with their own Braille and sign language, realizing the smooth communication among visually impaired, deaf-mute and normal individuals; 8) The ten Arabic numbers 0˜9 can help to unify the pronunciations of various language, however, the pronunciations of the ten Arabic numbers in countries and regions are different, which can be preserved considering both the their unity and diversity; 9) The ten Arabic numbers 0˜9 can truly help to achieve the correspondence and unity of phonetics and formation in any language. The words can be read quickly according to their structures, and the structures can be written down quickly according to the pronunciation; 10) As the word-formation symbols of intermediary language, the ten Arabic numbers 0˜9 are the word-formation symbols that do not exist in the current language, bringing people a wonderful and comforting feeling and facilitating the communication, and therefore can be widely accepted and popularized completely; 11) The ten Arabic numbers 0˜9 can help to unify the word-formation symbols of different human language, so it is more and more possible to unify global language; 12) The digitization of information and products derived from all language composed of the ten characters 0˜9 will promote the digitization of all industries and fields and accordingly speed up the development of the information age and the realization of the digitizedized human society; 13) The language composed of the ten characters 0˜9 makes various text input tools smaller in size and easier/more versatile in operation; 14) The ten Arabic numbers from 0˜9 will change the binary operation of computers, and the decimal system will make the computing speed even more unprecedented; 15) The ten Arabic numbers 0˜9 form a cryptographic system, making the decryption confusing and difficult; 16) The ten Arabic numbers 0˜9 are associated with musical tones, making the language musical and making it possible to communicate with extraterrestrial beings on other planets.

The digitized new language means a new development stage of human language, which changes language in the writing mode and the pronunciation while retaining the language rhythms. At the initial stage of the promotion of the digitized new language, the writing mode of current languages can also be changed while retaining the pronunciation.

The digitized new language does not mean abandoning the historical and cultural inheritance of various language that have been maintained until today. For any language, as long as the ten Arabic numbers 0˜9 are used as characters for conversion, the historical information can be preserved, and as long as the digitized new language is transformed into the original language, the historical information can be read smoothly.

### FIGURES

FIG. 1 Keyboard with a mouse-1;

FIG. 2 Keyboard with a mouse-2;

FIG. 3 Latin alphabet keyboard (with a mouse) for current language;

FIG. 4 Numeric keyboard with a mouse-1;

FIG. 5 Mouse with a numeric keyboard-1;

FIG. 6 Numeric keyboard with a mouse-2;

FIG. 7 Mouse with a numeric keyboard-2;

FIG. 8 digitized latin alphabet keyboard (with a mouse) for current language;

FIG. 9 Latin alphabet keyboard (mouse with a numeric keyboard) for current language;

FIG. 10 New Braille mobile phone keyboard;

FIG. 11 New digitized signs—representing ten characters 0˜9 and ending;

FIG. 12-1 Semantic sign, FIG. 12-2: Phrase, FIG. 12-3: Type 1, and FIG. 12-4 Comma for Type 1;

FIG. 13 Two ones, three ones, four ones and five ones;

FIG. 14 Sign of 65 ( [symbol] ) in the new Arabic;

FIG. 15 Sign of 40 (persons) in interpersonal language.

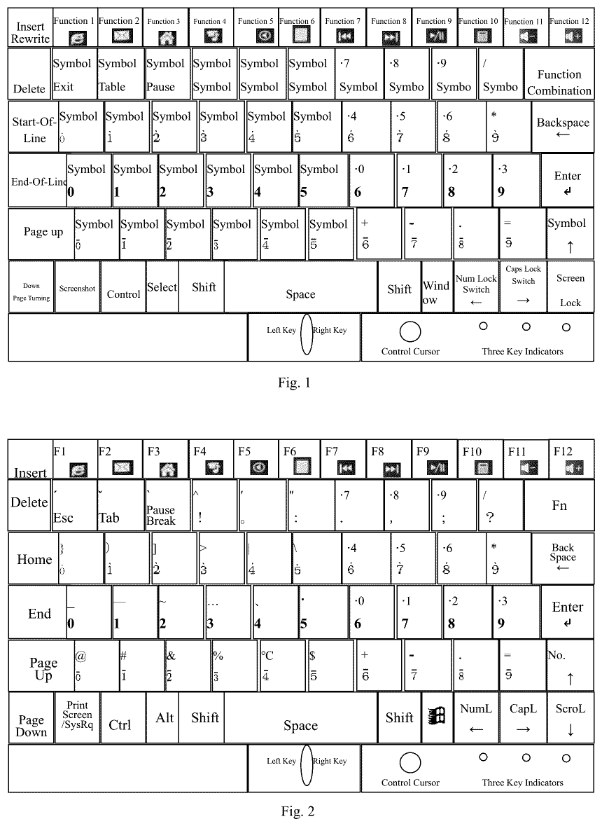

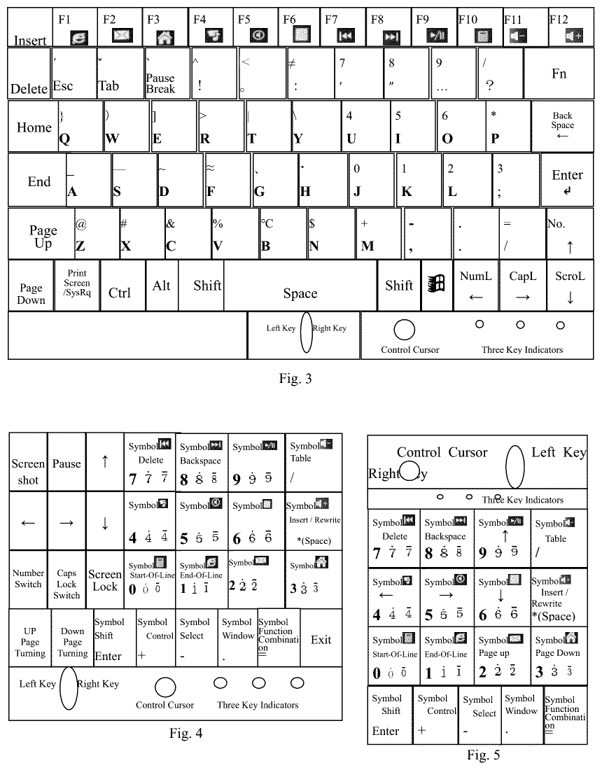

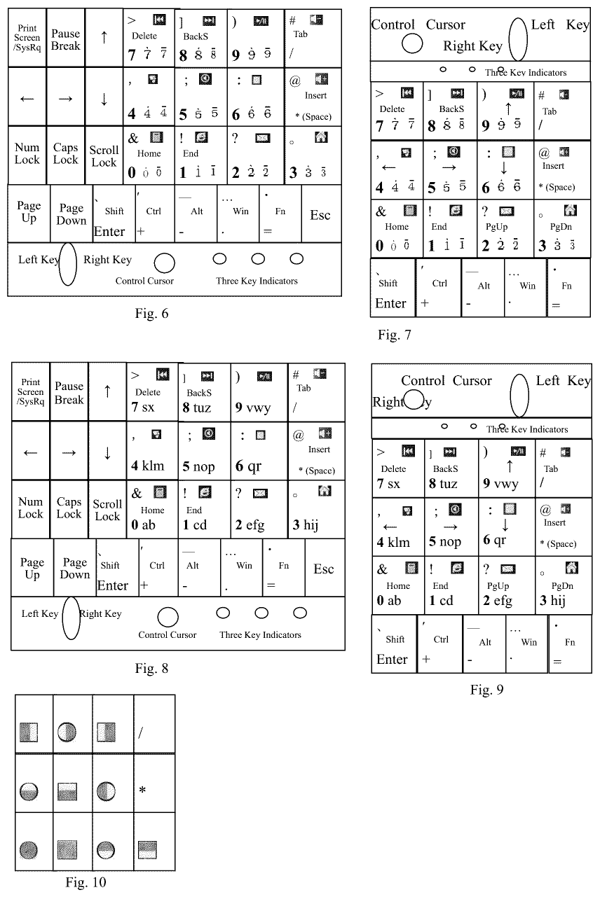

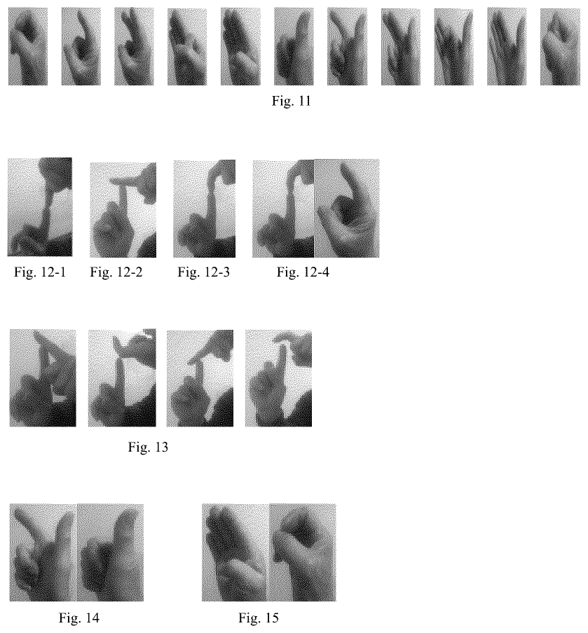

### EMBODIMENT

### I) Word

\dot{0}0 and \dot{3}5 (interpersonal/interstellar language) refer to “People and Language”, respectively;
810 and \dot{3}65 (New Albanian) refer to “tungjatjeta Hello and faleminderit Thanks” (Albanian), respectively;
65 and \dot{1}0 (New Arabic) refer to “ [symbol] and [symbol] Think” (Arabic), respectively;

010 and 7\dot{6}11 (New Assamese) refer to “ [symbol] Assamese and [symbol] Tomorrow” (Assamese), respectively;
3 \dot{7}2 and 234 (New Irish) refer to “éan Bird and eile Another” (Irish), respectively;
\dot{5}10 and \dot{3}65 (New Oriya) refer to [symbol] Welcome and [symbol] Please” (Oriya), respectively;

\dot{3}02 and 800 (New Basque) refer to “mesedez Please and zenbat How much” (Basque), respectively;
272 and 919 (New Persian) refer to [symbol] Inside and, [symbol] Entrance” (Persian), respectively;
034 and 209 (New Brezhoneg) refer to “Breton Brezhoneg and dehou Right” (Brezhoneg), respectively;
1\dot{0}18 and 0\dot{0}75 (New Korean) refer to “ [symbol] Nose and [symbol] Father” (Korean), respectively;
710 (New Chuvash) refers to “ [symbol] Chuvash” (Chuvash);
100 and \dot{5}44 (New Danish) refer to “Dansk Danish and velkommen Welcome” (Danish), respectively;
\dot{3}12 and 900 (New German) refer to “danke Thanks and Wunderbar, Wonderful” (German), respectively;
4\dot{2}10 and 0\dot{2}10 (New Russian) refer to “ [symbol] Man, and [symbol] Women” (Russian), respectively;
\dot{1}75 and 8\dot{9}02 (New French) refer to “Merci Thanks and adresse Mail Address” (French), respectively;

9\dot{3}09 and 3\dot{6}1 (New Sanskrit) refer to “ [symbol] Rainbow and Seal” (Sanskrit), respectively;
408 and 385 (New Finnish) refer to “kiitos Hello and heti Soon” (Finnish), respectively;
0\dot{2}55 and \dot{8}58 (New Georgian) refer to “ [symbol] Lady and [symbol] Customs” (Georgian), respectively;
085 and 238 (New Gujarati) refer to [symbol] Gujarati and [symbol] Sample” (Gujarati), respectively;
6\dot{2}04 and 6\dot{3}52 (New Chinese) refer to “Car and Ship” (Chinese), respectively;
842 and 0\dot{2}56 (New Hausa) refer to “tare Together and kishi Jealous” (Hausa), respectively;
7\dot{6}95 and 8\dot{0}80 (New Dutch) refer to “servies Dinner Service and kanon Cannon” (Dutch), respectively;
9\dot{5}48 and 4\dot{8}10 (New Galician) refer to “ouro Gold and final Final” (Galician), respectively;
608 and 322 (New Catalan) refer to “perdó Pardon and immens Immense” (Catalan), respectively;
8\dot{0}04 and 897 (New Cambodian) refer to [symbol] Fire and [symbol] Welcome” (Cambodian), respectively;
72 and \dot{7}22 (New Czech) refer to “ano Yes and les Forest” (Czech), respectively;
5\dot{4}85 and 3\dot{6}00 (New Kanarese) refer to “ [symbol] Bread and k [symbol] Lion” (Kanarese), respectively;
0\dot{2}10 and 9\dot{3}00 (New Croatian) refer to “mòna Mom and dúga Rainbow” (Croatian), respectively;
019 and 7\dot{6}10 (New Kashmir) refer to “ [symbol] Kashmir and [symbol] Saturday” (Kashmir), respectively;
716 (New Kurdish) refers to “ [symbol] Kurdish” (Kurdish);
7\dot{6}25 and 7\dot{0} (New Laotian) refer to [symbol] Sunday and [symbol] Export” (Laotian), respectively;
400 (New Kinyarwanda) refers to “Kinyarwanda Kinyarwanda” (Kinyarwanda);
326 and 7\dot{6}96 (New Maldivian) refer to [symbol] Lobster and [symbol] Sunshine” (Maldivian), respectively;
\dot{0}0 and 000 (New Malay) refer to “rakyar People and bukan Be Not” (Malay), respectively;
725 and 756 (New Marathi) refer to [symbol] Marathi and [symbol] Friendship (Marathi), respectively;
600 and 138 (New Malayalam) refer to “ [symbol] Malayalam and [symbol] Now” (Malayalam), respectively;
\dot{2}33 and 663 (New Macedonian) refer to [symbol] Farewell and [symbol] Sorry” (Macedonian), respectively;
7\dot{7}10 and 219 (New Manchu/Sibe) refer to [symbol] Month and [symbol] Country” (Manchu/Sibe), respectively;
131 and 7\dot{6}0 (New Mongolian) refer to [symbol] Farewell and [symbol] Tomorrow” (Mongolian), respectively;
\dot{3}00 and 7\dot{6}00 (New Bengali) refer to [symbol] Thanks and [symbol] Good Morning” (Bengali), respectively;
610 and \dot{3}10 (New Burmese) refer to [symbol] Hello and [symbol] Thanks” (Burmese), respectively;
10 and 536 (New Nepali) refer to [symbol] and [symbol] Nepalese” (Nepali), respectively;
\dot{9}33 and \dot{7}23 (New Norwegian) refer to “bananer Banana and epler Apple” (Norwegian), respectively;
62 and 8\dot{0}00 (new Panjabi) refer to [symbol] On and [symbol] Map” (Panjabi), respectively;
\dot{4}00 and 5\dot{0}49 (New Portuguese) refer to “tomada Socket and sapato Shoes” (Portuguese), respectively;
8\dot{4}21 and 217 (New Pashto) refer to [symbol] Winter and [symbol] Next” (Pashto), respectively;
7\dot{6}6 and 6\dot{6}(New Japanese) refer to [symbol] Good Night and [symbol] First Love (Japanese), respectively;
8\dot{2}47 and , \dot{0}90 (New Swedish) refer to “nordanvinden Northerly Wind and tok Silly” (Swedish), respectively;
9\dot{5}09 and 8\dot{0}33 (New Sinhalese) refer to [symbol] White and [symbol] Hot” (Sinhalese), respectively;
\dot{8}00 and 5\dot{3}70 (New Slovenian) refer to “voda Water and sladkor Sugar” (Slovenian), respectively;
05 and \dot{1}03 (New Thai) refer to [symbol] Airport and [symbol] absent-mindedness” (Thai), respectively;
709 and 209 (New Telugu) refer to [symbol] Telugu and [symbol] North” (Telugu), respectively;
46 and 7\dot{7}10 (New Tamil) refer to [symbol] Tamil and [symbol] Week” (Tamil), respectively;
400, \dot{5}56 (New Turkish) refer to “Merhaba Hello and Hoşgeldiniz Welcome”(Turkish), respectively;
\dot{2}73 and 975 (New Uigur) refer to [symbol] Hi and [symbol] Very Good” (Uigur), respectively;
12 and 410 (New Urdu) refer to [symbol] Front and [symbol] North” (Urdu), respectively;
300 and \dot{3}40 (New Spanish) refer to “HOLA Hello and Gracias Thanks” (Spanish), respectively;
608 and 5\dot{2}10 (New Hebrew) refer to [symbol] Welcome and [symbol] Autumn” (Hebrew), respectively;
4\dot{2}86 and 9\dot{6}92 (New Greek) refer to [symbol] Warrior and σκοτοζ Darkness” (Greek), respectively;
426 and 7\dot{6}09 (New Sindhi) refer [symbol] Sindhi and [symbol] Day” (Sindhi), respectively;
9\dot{1}10 and 110 (New Hungarian) refer to “pipa Pipe and cask Only” (Hungarian), respectively;
642 and 7\dot{6}94 (New Armenian) refer to [symbol] Armenian and [symbol] Tomorrow” (Armenian), respectively;
00 and 239 (New Igbo) refer to “gá Go and émù ridicule” (Igbo), respectively;
072 and 103 (New Italian) refer to “Buongionro Hello and Ciao Farewell” (Italian), respectively;
916 and \dot{9}09 (New Yiddish) refer to [symbol] Yiddish and [symbol] Flower” (Yiddish), respectively;
\dot{7}09 and 563 (New Hindi) refer to “Bridge and [symbol] Hello” (Hindi), respectively;
409 and 010 (New Indonesian) refer to “Kamu You and Bias Can” (Indonesian), respectively;
4\dot{1}03 and 235 (New English) refer to “Birthday and English” (English);
5\dot{7}00 and 300 (New Tibetan) refer to [symbol] Door and [symbol] Front” (Tibetan), respectively;
396 (New Zulu) refers to “howzit Hello” (Zulu);

### II) Phrase

5748̅4 (interpersonal/interstellar language) refers to “Arabic number”;
40̅400 (New Albanian) refers to “më fal Sorry” (Albanian);
90̅010 (New Arabic) refers to [symbol] Farewell” (Arabic);
01̅475 (New Avaric) refers to “ABap [symbol] I Avaric” (Avaric);
36̅018 (New Basque) refers to “Eskerrik asko Thanks” (Basque);
4481̅9 (New Korean) refers to [symbol] Passport” (Korean);
340̅19 (New German) refers to “ich liebe Bich I Love You” (German);
405̅66 (New Russian) refers to [symbol] [symbol] High-Speed Clutch” (Russian);
140̅595 (New French) refers to “C'est la vie This is Life ” (French);
5281̅0 (New Sanskrit) refers to “Pencil Sharpener” (Sanskrit);
8045̅1 (New Chinese) refers to “Digitized new language” (Chinese);
43̅624 (New Romanian) refers to “limba română Romanian ” (Romanian);
76̅690 (New Macedonian), referring to “ [symbol] Good Morning” (Macedonian);
14̅031 (New Mongolian) refers to [symbol] Bon voyage” (Mongolian);
253̅68 (New Norwegian) refers to “Godt nytt år Happy New Year” (Norwegian);
01̅000 (New Sinhalese) refers [symbol] New Starting Point” (Sinhalese);
47̅275 (New Shona) refers to “Mushe nushe Very Good” (Shona);
001̅02 (New Portuguese) refers to “bilhete de identidade ID card” (Portuguese);
99̅585 (New Tamil) refers to [symbol] Hotel” (Tamil);
75̅719 (Turkish) refers to “seni seviyomm I Love You” (Turkish);
10̅19 (New Uigur) refers to [symbol] Good Luck” (Uigur);
30̅108 (New Spanish) refers to “hasta luego Farewell” (Spanish);
665̅00 (New Hindi) refers to “Compass Box”(Hindi);
0610̅0 (New Indonesian) refers to “ember buat cuci muka Washbasin” (Indonesian);
8753̅4 (New English) refers to “United States of America” (English).

1. A digitized new language, namely a language that uses ten Arabic numbers 0˜9 as the unified word-formation symbols (characters for short) for all languages; the digitized new language is shortened as the new language and covers a digitized new current language and its corresponding Braille and sign language, a newly created interpersonal language and its corresponding Braille and sign language and a newly created interstellar language, wherein the characters are international codes within ten Arabic numbers 0˜9, a phonetic notation consists of internationally recognized ten consonants and ten vowels, and the pronunciations are mainly determined based on the internationally recognized phonetic symbols, namely 1, 2, 3, 4, 5, 6, 7 and \dot{1};
Pronunciation table of characters within 0˜9 for the digitized new language:

| Character | 0 | 1 | 2 | 3 | 4 | 5 | 6 | 7 | 8 | 9 |
|---|---|---|---|---|---|---|---|---|---|---|
| Pron. | [be] | [d [symbol] ] | [lei] | [mi] | [fa] | [so] | [nai] | [tin] | [k [symbol] n] | [pu] |

The characters of the ten Arabic numbers (0-9) are the same globally, however they are different in pronunciation in different countries and regions, they are distinctive pronunciations, however under the overall trend of unified pronunciations, people using different languages can also pronounce their own distinctive pronunciations, which reflect the combination of languages in unity, discrepancy and diversity;
1) Characters of the digitized new language
The characters of the digitized new language comprise of phonetic symbols, semantic symbols and formal symbols;
\textcircled{1} Phonetic symbol
A total of 110 phonetic symbols are set, including 10 single-phonetic-symbols 0˜9 with no consonants before vowels, and 100 “consonant+vowel” combined double-phonetic-symbols from 00 to 99, each word has 1˜2 phonetic symbols;
Phonetic symbol table of the digitized new language:

| | | Vowel characters 0~9 |
|---|---|---|
| | | Vowel sign |
| | | a a: [symbol] ai an [symbol] ao au [symbol] |
| | | e [symbol] ei en [symbol] er [symbol] |
| | | i [symbol] I _{I} ia ian [symbol] iao [symbol] |
| | | i: ie [symbol] in [symbol] iu [symbol] ju(:) [symbol] l m n |
| | | o [symbol] ou Θ Φ œ [symbol] oi [symbol] |
| | | u [symbol] u: [symbol] ua uai uan [symbol] [symbol] [symbol] |
| | | ui un uo [symbol] w y Y ü üan üe ün [symbol] |
| Consonant Mark sign | | Double-phonetic-symbol |
| Consonant | b [symbol] B _{B}β [symbol] ch [symbol] | 00 01 02 03 04 05 06 07 08 09 |
| characters | d [symbol] dr dz [symbol] d³ [symbol] | 10 11 12 13 14 15 16 17 18 19 |
| 0~9 | g [symbol] g G G [symbol] h ^{h} H H [symbol] | 20 21 22 23 24 25 26 27 28 29 |
| | [symbol] k [symbol] | 30 31 32 33 34 35 36 37 38 39 |
| | [symbol] | 40 41 42 43 44 45 46 47 48 49 |
| | m [symbol] n ⁿ N N [symbol] | 50 51 52 53 54 55 56 57 58 59 |
| | [symbol] P [symbol] q [symbol] | 60 61 62 63 64 65 66 67 68 69 |
| | r R _{R} [symbol] | 70 71 72 73 74 75 76 77 78 79 |
| | s ^{s} S [symbol] sh [symbol] | 80 81 82 83 84 85 86 87 88 89 |
| | [symbol] T tr ts [symbol] | 90 91 92 93 94 95 96 97 98 99 |
| | w ^{w} [symbol] x ^{x} x T y Y Y [symbol] | |
| | z [symbol] zh [symbol] | |

The digitized new language also digitizes the pronunciations of various current languages according to the “Phonetic Symbol Table of the digitized new language”, using only phonetic symbols rather than semantic symbols; In any language, each word has at most 3 syllables and 6 characters, with the last syllable being indispensable;
\textcircled{2} Semantic symbol
The semantic symbols comprise of 110 categories, including 10 categories of single-semantic-symbols and 100 categories of double-semantic-symbols, the identifier of the semantic symbols is “\dot{ }”, For a single-semantic-symbol, it can be added above it; For a double-semantic-symbol, it can be added above the second semantic symbol, semantic symbol vowels are pronounced with a long sound [:], 0 [be:], 1 [d [symbol] : ], 2 [lei:], 3 [mi:], 4 [fa:], 5 [so:], 6 [nai:], 7 [ti: n], 8 [ka:n]and 9 [pu:];
Semantic symbol table of the digitized new language:

| Semantic | |
|---|---|
| sym. | |
| Consonant | |
| Mark | Semantic classification |
| \dot{⁰} | Related to people |
| \dot{¹} | Related to brain and heart |
| \dot{²} | Related to mouth |
| \dot{³} | Related to speech |
| \dot{⁴} | Related to hands |
| \dot{⁵} | Related to walking |
| \dot{⁶} | Related to metals |
| \dot{⁷} | Related to trees |
| \dot{⁸} | Related to water |
| \dot{⁹} | Related to grass and flowers |
| 0\dot{⁰} | Related to parents |
| 0\dot{¹} | Related to children |
| 0\dot{²} | Related to women |
| 0\dot{³} | Related to the body |
| 0\dot{⁴} | Related to head |
| 0\dot{⁵} | Related to angles |
| 0\dot{⁶} | Related to ear |
| 0\dot{⁷} | Related to sound |
| 0\dot{⁸} | Related to face |
| 0\dot{⁹} | Related to eyes |
| 1\dot{⁰} | Related to seeing |
| 1\dot{¹} | Related to nose |
| 1\dot{²} | Related to fragrance |
| 1\dot{³} | Related to open mouth breathing |
| 1\dot{⁴} | Related to tongue |
| 1\dot{⁵} | Related to saline tastes |
| 1\dot{⁶} | Related to spicy tastes |
| 1\dot{⁷} | Related to teeth |
| 1\dot{⁸} | Related to bone |
| 1\dot{⁹} | Related to blood |
| 2\dot{⁰} | Related to meat |
| 2\dot{¹} | Related to skin |
| 2\dot{²} | Related to hair |
| 2\dot{³} | Related to wings |
| 2\dot{⁴} | Related to knocking |
| 2\dot{⁵} | Related to claws |
| 2\dot{⁶} | Related to feet |
| 2\dot{⁷} | Related to standing |
| 2\dot{⁸} | Related to horses |
| 2\dot{⁹} | Related to cattle |
| 3\dot{⁰} | Related to sheep |
| 3\dot{¹} | Related to pigs |
| 3\dot{²} | Related to dogs |
| 3\dot{³} | Related to mice |
| 3\dot{⁴} | Related to tigers |
| 3\dot{⁵} | Related to deer |
| 3\dot{⁶} | Related to wild animals |
| 3\dot{⁷} | Related to birds |
| 3\dot{⁸} | Related to insects |
| 3\dot{⁹} | Related to fish |
| 4\dot{⁰} | Related to tortoises and frogs |
| 4\dot{¹} | Related to growth |
| 4\dot{²} | Related to force |
| 4\dot{³} | Related to diseases |
| 4\dot{⁴} | Related to bad luck |
| 4\dot{⁵} | Related to ghosts |
| 4\dot{⁶} | Related to God |
| 4\dot{⁷} | Related to clothing |
| 4\dot{⁸} | Related to silk thread |
| 4\dot{⁹} | Related to cloth and silk |
| 5\dot{⁰} | Related to hide |
| 5\dot{¹} | Related to food |
| 5\dot{²} | Related to paddy |
| 5\dot{³} | Related to grain |
| 5\dot{⁴} | Related to wheat |
| 5\dot{⁵} | Related to melons and beans |
| 5\dot{⁶} | Related to wine |
| 5\dot{⁷} | Related to doors |
| 5\dot{⁸} | Related to furnishings |
| 5\dot{⁹} | Related to factory buildings |
| 6\dot{⁰} | Related to caves |
| 6\dot{¹} | Related to urban and rural areas |
| 6\dot{²} | Related to vehicles |
| 6\dot{³} | Related to boats |
| 6\dot{⁴} | Related to bottle/can appliances |
| 6\dot{⁵} | Related to dishes and utensils |
| 6\dot{⁶} | Related to containers |
| 6\dot{⁷} | Related to cooking utensils |
| 6\dot{⁸} | Related to measuring instruments |
| 6\dot{⁹} | Related to nets |
| 7\dot{⁰} | Related to agricultural tools |
| 7\dot{¹} | Related to tools |
| 7\dot{²} | Related to axe |
| 7\dot{³} | Related to spears |
| 7\dot{⁴} | Related to bows and crossbows |
| 7\dot{⁵} | Related to arrows |
| 7\dot{⁶} | Related to the sun |
| 7\dot{⁷} | Related to the moon |
| 7\dot{⁸} | Related to evening and night |
| 7\dot{⁹} | Related to photoelectricity |
| 8\dot{⁰} | Related to fire |
| 8\dot{¹} | Related to air |
| 8\dot{²} | Related to wind |
| 8\dot{³} | Related to rain |
| 8\dot{⁴} | Related to coldness |
| 8\dot{⁵} | Related to jade |
| 8\dot{⁶} | Related to stones |
| 8\dot{⁷} | Related to mountains |
| 8\dot{⁸} | Related to farmland |
| 8\dot{⁹} | Related to soils |
| 9\dot{⁰} | Related to hills |
| 9\dot{¹} | Related to bamboo |
| 9\dot{²} | Related to slice |
| 9\dot{³} | Related to colors |
| 9\dot{⁴} | Related to cyan and red |
| 9\dot{⁵} | Related to yellow and white |
| 9\dot{⁶} | Related to black |
| 9\dot{⁷} | Related to money and commodities |
| 9\dot{⁸} | Related to roads |
| 9\dot{⁹} | Related to directions and flags |

\textcircled{3} Formal symbol
The formal symbols comprise of ten categories (0-9), one word can have 1-4 formal symbols as needed or be provided without any formal symbol; The formal symbols refer to the classification of basic letters or stroke forms used for various languages, which basically reflects the letter and stroke form orders of different languages; The following table shows the Latin alphabet, Arabic alphabet, Slavic alphabet used by many countries and the unique letters or stroke forms of a country or nation; The letters of each language are arranged on the ten numeric keys (0-9) of the numeric keyboard to achieve inputting various letters and languages through the numeric keyboard;
Formal symbol table of the digitized new language:

| Formal | |
|---|---|
| symbol | The basic letters or stroke forms used for various languages worldwide |
| 0 | 1)a b, 2) [symbol] 3)a σ B, 4) [symbol] , 5) [symbol] , 6) [symbol] , 7) [symbol] , |
| | 8) [symbol] , 9) [symbol] , 10) [symbol] , 12) [symbol] |
| | [symbol] 16) [symbol] 18) [symbol] |
| | 20) [symbol] 23) [symbol] |
| | 25) [symbol] 27) [symbol] |
| | 30)αβ, 31) [symbol] , 32) [symbol] , 33) [symbol] , 34) [symbol] |
| 1 | 1)c d, 2) [symbol] , 5) [symbol] |
| | 8) [symbol] 10) [symbol] 12) [symbol] |
| | 14) [symbol] 17) [symbol] |
| | 20) [symbol] [symbol] |
| | [symbol] [symbol] |
| | 30)γδε, 31) [symbol] |
| 2 | 1)e f g, 2) [symbol] [symbol] |
| | 9) [symbol] 12) - / [symbol] |
| | 14) [symbol] 17) [symbol] |
| | 20) [symbol] 23) [symbol] |
| | 25) [symbol] 27) [symbol] |
| | 30)ζηθ, 31) [symbol] 33) [symbol] |
| 3 | 1)h i j, 2) [symbol] [symbol] |
| | 9) [symbol] [symbol] |
| | 15) [symbol] 18) [symbol] |
| | 21) [symbol] [symbol] |
| | 26) [symbol] 28) [symbol] |
| | 32) [symbol] |
| 4 | 1)k l m, 2) [symbol] 5) [symbol] |
| | 8) [symbol] 11) [symbol] |
| | 13) [symbol] 16) [symbol] |
| | 19) [symbol] 22) [symbol] |
| | 25) [symbol] 28) [symbol] |
| | 31) [symbol] 33) [symbol] |
| 5 | 1)n o p, 2) [symbol] 6) [symbol] |
| | 9) [symbol] 12) [symbol] |
| | 14) [symbol] 17) [symbol] |
| | 21) [symbol] 24) [symbol] |
| | 26) [symbol] 29)30, [symbol] |
| | 32) [symbol] |
| 6 | 1)q r, 2) [symbol] 6) [symbol] |
| | 8) [symbol] 11) [symbol] |
| | 13) [symbol] 16) [symbol] |
| | 19) [symbol] 22) [symbol] |
| | 25) [symbol] 27) [symbol] |
| | 30)π ρ, 31) [symbol] 33) [symbol] |
| 7 | 1)s, x, 2) [symbol] 5) [symbol] |
| | 8) [symbol] 11) [symbol] |
| | 14) [symbol] 17) [symbol] |
| | 20) [symbol] 23) [symbol] |
| | 25) [symbol] 27) [symbol] |
| | 30) σ τ, 31) [symbol] 33) [symbol] |
| 8 | 1)t u z, 2) [symbol] 5) [symbol] |
| | 8) [symbol] 12) [symbol] |
| | 14) [symbol] 17) [symbol] |
| | 20) [symbol] 23) [symbol] |
| | 25) [symbol] 27) [symbol] |
| | 30) [symbol] 33) [symbol] |
| 9 | 1)v w y, 2)3, [symbol] 5) [symbol] |
| | 8) [symbol] 11) [symbol] |
| | 13) [symbol] 16) [symbol] |
| | 19) [symbol] 22) [symbol] |
| | 25) [symbol] 27) [symbol] |
| | 30)χψω, 31) [symbol] 33) [symbol] |

\textcircled{4} Difference between characters and numbers
The ten Arabic numbers (0-9) involve both character and number meanings in the digitized new language, namely a character and the corresponding number are represented in the same form; When only one Arabic number is used, it refers to both a word and a number with the same meaning; When 2˜6 Arabic numbers are used, the difference between the characters and numbers is that adding the number identifier of “⋅” before an Arabic number string represents a number rather than a character; When two or more consecutive Arabic numbers represent a number, the number identifier “⋅” should be added at the beginning and end; Characters do not have any symbols, so those with symbols represent numbers, regardless of being at the beginning, in the middle or at the end; \textcircled{5} Simplification and ligature of characters
Although the ten Arabic numbers 0˜9 are widely used in the world and are the most popular word-formation symbols, they still need to be simplified;
Detailed cimnlificatinn and ligature of characters

| Simplification | 0 | [symbol] | 1 | [symbol] | 2 | [symbol] | 3 | [symbol] | 4 | ∠ | 5 | [symbol] | 6 | [symbol] | 7 | [symbol] | 8 | [symbol] | 9 | [symbol] |
|---|---|---|---|---|---|---|---|---|---|---|---|---|---|---|---|---|---|---|---|---|
| 0 [symbol] | 00 | [symbol] | 01 | [symbol] | 02 | [symbol] | 03 | [symbol] | 04 | [symbol] | 05 | [symbol] | 06 | [symbol] | 07 | [symbol] | 08 | [symbol] | 09 | [symbol] |
| 1 [symbol] | 10 | [symbol] | 11 | [symbol] | 12 | [symbol] | 13 | [symbol] | 14 | [symbol] | 15 | [symbol] | 16 | [symbol] | 17 | [symbol] | 18 | [symbol] | 19 | [symbol] |
| 2 [symbol] | 20 | [symbol] | 21 | [symbol] | 22 | [symbol] | 23 | [symbol] | 24 | [symbol] | 25 | [symbol] | 26 | [symbol] | 27 | [symbol] | 28 | [symbol] | 29 | [symbol] |
| 3 [symbol] | 30 | [symbol] | 31 | [symbol] | 32 | [symbol] | 33 | [symbol] | 34 | [symbol] | 35 | [symbol] | 36 | [symbol] | 37 | [symbol] | 38 | [symbol] | 39 | [symbol] |
| 4 [symbol] | 40 | [symbol] | 41 | [symbol] | 42 | [symbol] | 43 | [symbol] | 44 | [symbol] | 45 | [symbol] | 46 | [symbol] | 47 | [symbol] | 48 | [symbol] | 49 | [symbol] |
| 5 [symbol] | 50 | [symbol] | 51 | [symbol] | 52 | [symbol] | 53 | [symbol] | 54 | [symbol] | 55 | [symbol] | 56 | [symbol] | 57 | [symbol] | 58 | [symbol] | 59 | [symbol] |
| 6 [symbol] | 60 | [symbol] | 61 | [symbol] | 62 | [symbol] | 63 | [symbol] | 64 | [symbol] | 65 | [symbol] | 66 | [symbol] | 67 | [symbol] | 68 | [symbol] | 69 | [symbol] |
| 7 [symbol] | 70 | [symbol] | 71 | [symbol] | 72 | [symbol] | 73 | [symbol] | 74 | [symbol] | 75 | [symbol] | 76 | [symbol] | 77 | [symbol] | 78 | [symbol] | 79 | [symbol] |
| 8 [symbol] | 80 | [symbol] | 81 | [symbol] | 82 | [symbol] | 83 | [symbol] | 84 | [symbol] | 85 | [symbol] | 86 | [symbol] | 87 | [symbol] | 88 | [symbol] | 89 | [symbol] |
| 9 [symbol] | 90 | [symbol] | 91 | [symbol] | 92 | [symbol] | 93 | [symbol] | 94 | [symbol] | 95 | [symbol] | 96 | [symbol] | 97 | [symbol] | 98 | [symbol] | 99 | [symbol] |

After the characters are simplified, for 2 characters, they can be ligatured from up to down; for 3 characters, 1 and 2 can be ligatured from up to down, while 3 can be written separately, for 4 characters, 1 and 2 as well as 3 and 4 can be ligatured from up to down; for 5 characters, 1 and 2 as well as 3 and 4 can be ligatured from up to down, 5 can be written separately; for 6 characters, 1 and 2, 3 and 4 as well as 5 and 6 can be ligatured from up to down; The ligatured characters will also be used as shorthand symbols for various languages;
2) Formation method of words and phrases of the digitized new language
The formation method of the digitized new language includes words and phrases, each word and phrase can have at most 5 characters, any word or phrase in the same language is unique and will not repeat;
\textcircled{1} Word-formation method
The “word” in the present invention refers to a single word or word, words are divided into three parts, namely phonetic, semantic and formal parts, and each part represents a different meaning; The formation of a word involves the following four items:
When a word only involves “phonetic symbol”, it can have 1˜2 characters;
When the word involves the combination of “semantic symbol +phonetic symbol”, it can have 2˜4 characters;
When the word involves the combination of “formal symbol +phonetic symbol”, it can have 2˜5 characters;
When the word involves the combination of “semantic symbol +formal symbol +phonetic symbol”, it can have 3˜5 characters;
\textcircled{2} Phrase-formation method
The “phrase” in the present invention refers to a collocation or phrase, phrases can help to reduce the number of characters and speed up the writing, their identifier is “ ”, The phrase vowels are pronounced in a falling tone and then a rising tone [\check{ }], 0̅ [bě], 1̅ [d [symbol] ], 2̅ [ěi], 3̅[m\check{i}], 4̅ [f\check{a}], 5̅[s\check{o}], 6̅ [n\check{a}i], 7̅[t\check{i}n], 8̅ [k [symbol] n] and 9̅ [p\check{u}]; The formation of a phase involves the following three items:
For a phrase formed by two words: the first word uses the first 2 characters, while the second uses the last 3 characters, namely 2+3, and the identifier “ ” shall be added above the second character;
For a phrase formed by three words: the first word uses the first 1 character, the second uses the first 2 characters and the last uses the last 2 characters, namely 1+2+2, and the identifier “ ” shall be added above the third character;
For a phrase formed by four or more words: the first, second and third words use the first 1 character, while the last uses the last 2 characters, namely 1+1+1+2, and the identifier “ ” shall be added above the fourth character;
Regardless of the item, the phrase always retains the phonetic symbol of the last syllable of the last word;
\textcircled{3} Arrangement of words and phrases
Words and phrases are arranged linearly from left to right in single lines, three to five characters can also be arranged in two lines, three characters are arranged with 1 on the left, top and bottom, respectively, four characters are arranged with 2 on the top and bottom, respectively, five characters are arranged with 2 on the top and bottom, respectively and 1 on the right, six characters are arranged with 3 on the top and bottom, respectively;
\textcircled{4} Ellipsis, abbreviation and font size of words and phrases
(1) Omission of repeated characters: Regardless of words or phrases, if a character will be repeated, ellipses [symbol] can be used after it to avoid repetition, which indicate that two, three, four or five characters are the same, respectively, when a character will be repeated six times, the ellipsis \tilde{ } can be used after it, omission vowels are pronounced in a rising tone [\acute{ }], 0 [bé], 1 [d [symbol] ], 2 [léi], 3 [mí], 4 [fá], 5 [só], 6 [nái], 7 [tín], 8 [k [symbol] n] and 9 [pú];
(2) Abbreviation refers to using only one or two characters from a word or phrase comprising of 3-5 characters, the identifier “ ” of abbreviation is the same as that used for phrases, the difference is that it is added above the first character, abbreviation vowels are pronounced in a falling tone and then a rising tone [\check{ }], 0̅ [bě], 1̅ [d [symbol] ], 2̅ [ěi], 3̅[m\check{i}], 4̅ [f\check{a}], 5̅[s\check{o}], 6̅ [n\check{a}i], 7̅[t\check{i}n], 8̅ [k [symbol] n] and 9̅ [p\check{u}];
(3) At most 3 big/small font sizes for characters can be used, the font size for the first character shall be the same as that used throughout the text, and the small font size shall be used for the following one or two characters, big/small font sizes shall be pronounced in a falling tone [\grave{ }], 0 [bè],1 [d [symbol] ], 2 [lèi], 3 [mì], 4 [fà], 5 [sò], 6 [nài], 7 [tìn], 8 [k [symbol] n] and 9 [pù];
3) Syllables of the digitized new language
For the digitized new language, a character means a syllable, in order to reduce the number of syllables, each word or phrase can only be pronounced with a maximum of two syllables;
\textcircled{1} Monosyllable: Including single-character, double-character and triple-character;
Single-character: namely a word or a number, both have the same form and pronunciation, 0 [be] and 1 [d [symbol] ], 2 [lei], 3 [mi], 4 [fa], 5 [so], 6 [nai], 7 [tin], 8 [k [symbol] n] and 9 [pu]; Single-character means a zero-consonant vowel, namely there is no any consonant before the vowel, the identifier “\dot{ }” for the zero consonant vowel is the same as that used for semantic symbols, the difference is that it is added above the last character representing a phonetic symbol, the zero-consonant vowels are pronounced with a long sound [:], 0 [be:], and 1 [d [symbol] :], 2 [lei:], 3 [mi:], 4 [fa:], 5 [so:], 6 [nai:], 7 [ti: n], 8 [k [symbol] : n] and 9 [pu:];
Double-character: namely “consonant +vowel”, with the first character is a consonant and the second character, a vowel, the consonant and vowel are pronounced together as follows:

| | | Second character | | | | | | | | | |
|---|---|---|---|---|---|---|---|---|---|---|---|
| First | | 0 | 1 | 2 | 3 | 4 | 5 | 6 | 7 | 8 | 9 |
| character | | [be] | [d [symbol] ] | [lei] | [mi] | [fa] | [so] | [nai] | [tin] | [k [symbol] n] | [pu] |
| 0 | [be] | [bé] | [b [symbol] ] | [bei] | [bi] | [ba] | [bo] | [bai] | [bin] | [b [symbol] n] | [bu] |
| 1 | [d [symbol] ] | [de] | [d [symbol] ] | [dei] | [di] | [da] | [do] | [dai] | [din] | [d [symbol] n] | [du] |
| 2 | [lei] | [le] | [l [symbol] ] | [léi] | [li] | [la] | [lo] | [lai] | [lin] | [l [symbol] n] | [lu] |
| 3 | [mi] | [me] | [m [symbol] ] | [mei] | [mí] | [ma] | [mo] | [mai] | [min] | [m [symbol] n] | [mu] |
| 4 | [fa] | [fe] | [f [symbol] ] | [fei] | [fi] | [fá] | [fo] | [fai] | [fin] | [f [symbol] n] | [fu] |
| 5 | [so] | [se] | [s [symbol] ] | [sei] | [si] | [sa] | [só] | [sai] | [sin] | [s [symbol] n] | [su] |
| 6 | [nai] | [ne] | [n [symbol] ] | [nei] | [ni] | [na] | [no] | [nái] | [nin] | [n [symbol] n] | [nu] |
| 7 | [tin] | [te] | [t [symbol] ] | [tei] | [ti] | [ta] | [to] | [tai] | [tín] | [t [symbol] n] | [tu] |
| 8 | [k [symbol] n] | [ke] | [k [symbol] ] | [kei] | [ki] | [ka] | [ko] | [kai] | [kin] | [k [symbol] n] | [ku] |
| 9 | [pu] | [pe] | [p [symbol] ] | [pei] | [pi] | [pa] | [po] | [pai] | [pin] | [p [symbol] n] | [pú] |

Triple-character: The vowel of the first character is changed to an elision [ [symbol] ], and the pronunciation for the last two characters is the same as that for double-characters, namely “consonant+(ellipsis)+consonant+vowel”; The first character is pronounced [ [symbol] ] when having a semantic symbol;
\textcircled{2} Didisyllable: including quadruple character and quintuple-characters;
Quadruple-character: Two characters form one syllable, the pronunciation method is the same as that for double-characters;
Quintuple-character: The first two characters form one syllable, the pronunciation is the same as that for double-characters; The last three characters form one syllable, the pronunciation is the same as that for triple-characters;
For six characters, every three characters form one syllable, and the pronunciation the same as that for triple-characters.

2. The digitized new language according to claim 1, wherein a digitized new Braille uses blind symbols to replace 0-9 ten characters of the digitized new language; for the digitized new Braille, at most six dots are arranged for each square, among which three dots take a column, and six dots take two columns for touch-reading and writing from the left to the right and from the top to the bottom; a square refers to a complete independent unit, a single word (word), phrase, punctuation mark and letter, etc; convex and concave dots are set, including their corresponding circular, semi-circular, square and semi-square dots;
1) Convex dots represent ten types of characters that protrude out of the surface, the circular dot represents Convex 0, the semi-circular dots are set at four positions, namely the top, bottom, left and right representing Convexes 2, 4, 6 and 8, respectively; The square dot represents Convex 1, the half-square dots are set at four positions, namely the top, bottom, left and right representing Convexes 3, 5, 7 and 9, respectively; When representing a word, the corresponding convex dot blind symbols can appear directly; When representing a semantic symbol, each convex dot blind symbol with a concave dot on the top represent convex \dot{0}, \dot{1}, \dot{2}, \dot{3}, \dot{4}, \dot{5}, \dot{6}, and \dot{9} respectively; When representing a phrase, each convex dot blind symbol with a concave dash on the top represent convex 0̅, 1̅, 2̅, 3̅, 4̅, 5̅, 6̅, and 9̅ respectively;
2) Concave dots represent ten types of Braille symbols that concave into the surface, the circular dot represents Concave 0, the semi-circular dots are set at four positions, namely the top, bottom, left and right representing Concaves 2, 4, 6 and 8, respectively; The square dot represents Concave 1, the half-square dots are set at four positions, namely the top, bottom, left and right representing Convexes 3, 5, 7 and 9, respectively;
When representing types, the concave blind symbols will appear first, followed by different contents after different concave dots as follows:
The appeared Concave 0 indicates that an Arabic number will appear after it;
The appeared Concave 1 indicates that a punctuation mark will appear after it;
The appeared Concave 2 indicates that a mathematical symbol will appear after it;
The appeared Concave 3 indicates that a commercial symbol will appear after it;
The appeared Concave 4 indicates that a Latin letter will appear after it; One or two blind symbols represent a letter;
The appeared Concave 5 indicates that an Arabic letter will appear after it; One or two blind symbols represent a letter;
The appeared Concave 6 indicates that a Slavic letter will appear after it; One or two blind symbols represent a letter;
The appeared Concave 7 indicates that a letter used separately by a country or nation will appear after it; One or two blind symbols represent a letter;
Concave 8 or 9 is set dependent on the language.

3. The digitized new language according to claim 1, wherein a digitized new sign language uses signs to replace 0-9 ten characters of the digitized new language;
1) The digitized new sign language uses five fingers of one hand to represent the ten characters (0-9) of the digitized new language, among them the thumb represents 5, and the index finger, middle finger, ring finger and little finger each represent 1;
Representation of Character 0: Forming a circle with the tip of the thumb and the other four fingers;
Representation of Character 1: Stretching out the index finger and folding the remaining fingers;
Representation of Character 2: Stretching out the index finger and middle finger and folding the remaining fingers;
Representation of Character 3: Stretching out the middle finger, ring finger and little finger and folding the remaining fingers;
Representation of Character 4: Stretching out the index finger, middle finger, ring finger and little finger and folding the remaining finger;
Representation of Character 5: Stretching out the thumb and folding the remaining fingers;
Representation of Character 6: Stretching out the thumb and index finger to form an angle and folding the remaining fingers;
Representation of Character 7: Stretching out the thumb, index finger and middle finger to form an angle and folding the remaining fingers;
Representation of Character 8: Stretching out the thumb, middle finger, ring finger and little finger and folding the index finger;
Representation of Character 9: Stretching out the five fingers with the thumb and the remaining four fingers forming an angle;
Representation of an end: Making a fist;
When both hands are used, the representations can be speed up from the left hand to the right;
2) When representing words, signs can be used directly; When representing a semantic symbol, place the index finger of the other hand vertically on one of the fingers representing a number; When representing a phrase, place the index finger of the other hand horizontally on one of the fingers representing a number;
When representing types, bend and place the index finger of the other hand on one tip of the fingers representing a number, placing on the fingers representing different numbers means different contents as follows:
Placing on the finger representing 0 means that an Arabic number will appear after it;
Placing on the finger representing 1 means that a punctuation mark will appear after it;
Placing on the finger representing 2 means that a mathematical symbol will appear after it;
Placing on the finger representing 3 means that a commercial symbol will appear after it;
Placing on the finger representing 4 means that a Latin letter will appear after it, and one or two signs represent a letter;
Placing on the finger representing 5 means that an Arabic letter will appear after it, and one or two signs represent a letter;
Placing on the finger representing 6 means that a Slavic letter will appear after it, and one or two signs represent a letter;
Placing on the finger representing 7 means that a letter used separately by a country or nation will appear after it, and one or two signs represent a letter;
The meaning of placing on the finger representing 8 or 9 is set dependent on the language;
When representing that two numbers are the same, the index finger tip of the other hand should tilt upward in the form of \acute{ }; When representing that three numbers are the same, the index finger of the other hand should bend in the form of \check{ } and be placed on that finger; When representing that four numbers are the same, the tip of the index finger of the other hand should tilt downward in the form of \grave{ }; When representing that five numbers are the same, the index finger of the other hand should bend in the form of \hat{ } and cover on that finger.

4. The digitized new language according to claim 1, wherein a digitized new current language uses 0˜9 ten Arabic numbers as characters to replace letters and stroke forms of the current language, implementing the digitized new language in the current language;
1) Braille of the digitized new current language
A Braille of the digitized new current language, wherein the digitized characters of the current new language are converted into blind symbols used in the digitized new Braille;
2) Sign language of the digitized new current language
A sign language of the digitized new current language, wherein the digitized characters of the current new language are converted into signs used in the digitized new sign language.

5. The digitized new language according to claim 1, wherein an interpersonal language is that:
I) Nature
The interpersonal language is an international digitized all-purpose language created by using ten Arabic numbers 0˜9 as word-formation symbols and rooting in the current human languages;
II) Functional words
According to the syntactic functions, the words of the interpersonal language are: The subject words including nouns, pronouns and numerals; The predicate including verbs; Object words including nouns, pronouns and numerals; Adjunct words including adjectives (as attributes) and adverbs (as adverbials); Conjunctive words including prepositions and conjunctions; Independent words including interjections and onomatopoeia; Tense words including past/present/future/progressive/perfect tenses and other tense expressions;
Nouns, verbs, adjectives and adverbs should all remain in their original forms;
III) Semantic multi-part-of-speech words
A word having different parts-of-speech at different positions of a sentence, which involves semantic multi-part-of-speech and therefore it is unnecessary to coin related words, such words are: nouns with verb and adjective parts-of-speech, pronouns with possessive relationships; verbs with transitive, intransitive and noun parts-of-speech, adjectives with adverb part-of-speech and adverb with adjective part-of-speech;
IV) The use of \dot{3} represents a plural;
V) Basic sentence patterns
(Attribute) subject+(adverbial) predicate (transitive verb)+(attribute) (indirect object)+(attribute) direct object;
(Attribute) subject+(adverbial) predicate (intransitive verb);
VI) Tenses
Tenses are expressed using tense words or adverbials of time: Past tense—10, present tense—06 (usually not used), future tense—50, progressive tense—53 and perfect tense—16;
VII) Syntactical structures
Before the verb of an affirmative sentence, a negative sentence, passive sentence (transposition of the subject and object) and interrogative sentence can be formed by adding a negative meaning (80), passive meaning (76) and questioning meaning (78, at the end of the sentence), respectively;
Subjunctive sentences, imperative sentences and other sentences can be expressed with the relevant words and phrases;
VIII) Puntuation marks
The caesura sign, dash, full stop, ellipsis and hyphen or alternate character in the interpersonal language are [symbol] ”, “—”, “○”, “ . . . ” and “˜”, respectively;
1) An Interpersonal language Braille, wherein the characters of the interpersonal language are converted into blind symbols of the digitized new Braille;
2) An interpersonal sign language, wherein the characters of the interpersonal language are converted into signs of the digitized new sign language.

6. The digitized new language according to claim 5, wherein the interpersonal language is an interstellar language, and graphics are provided based on the phonetic, semantic and formal designs of the interpersonal language.

7. An input method for the digitized new language, wherein the input method is completed based on the characters of words or phrases, namely one character can be input by pressing a key once, the number of characters is equivalent to the times to be pressed on the keys, which can be ended by pressing the space bar; For square words arranged in two lines, each word or phrase will end naturally after the keys are pressed 5 times, the input of those words by pressing the keys less than 5 times can end by pressing the space bar; Six characters can be input by pressing the key combination of “.” and “=”, which should be pressed again for an end; When inputting a semantic symbol within \dot{0}˜\dot{9} and a phrase within 0̅˜9̅ on the numeric keyboard, the combination of the corresponding key and another key should be pressed;
The digitized new language will make the development of software and hardware for handwriting and speech input more mature, achieving a more accurate recognition.

8. An input tool for the digitized new language, wherein it includes a keyboard with a mouse, a numeric keyboard with a mouse, a mouse with a numeric keyboard and a new Braille mobile phone keyboard;
1) A keyboard with a mouse, wherein both hands can easily operate the mouse without leaving the keyboard, and keyboard can be operated without leaving the mouse; The keyboard includes click keys and key combinations;
The click keys are used for achieving the keyboard's functions such as Insert/Rewrite, Delete, Start-Of-Line, End-Of-Line, Page Up, Page Down, Screenshot, Control, Select, Shift, Space, Window, Cursor Left/Right/Up/Down, Enter, Backspace, Function Combination, Pause, Table, Exit and Functions 1-12; After clicking on the functional key combination, the numeric keyboard can be started and the operations of the ten numbers 0˜9 and six operation symbols namely “/”, “*”, “+”, “−”, “.” and “=” can be completed;
For the key combinations, the “Shift plus ←, → and ↓,” refers to Num Lock, Caps Lock and Screen Lock, respectively, the “Shift plus symbol key” refers to inputting the shift symbol; When combined with other keys, the Control, Select, Window and Function Combination of the key combinations will achieve different functions;
Multimedia functions include Browser, Email, Favorites, Multimedia Player, Mute, Stop, Previous, Next, Play/Pause, Calculator, Volume − and Volume +;
When inputting the current language, the character keys and symbol keys can be changed to the letters and symbols of the required language to meet the keyboard input requirements for various languages;
Below the keyboard are the mouse wheel, left/right keys, control cursor device, as well as three key indicators: Num Lock, Caps Lock and Screen Lock, the mouse can be easily operated by simply moving down the left or right thumb, and the cursor can be controlled by moving down the right thumb;
The screen can be set through the top of the keyboard to display the input content; The relevant purposes can be added depending on the industry;
2) A numeric keyboard with a mouse, wherein the functions of the numeric keyboard and the mouse can be combined skillfully, and the operations can be completed with one or both hands; The numeric keyboard includes click keys, long-press keys and key combinations;
The click keys are used for inputting the ten characters 0˜9 and mathematical operation symbols “/”, “*”, “.”, “+”, “−” and “=” and achieving the keyboard functions such as Space, Exit, Enter, Page Down, Page Up, Num Lock, Caps Lock, Screen Lock, Cursor Left/Right/Up/Down, Screenshot and Pause;
The long-press keys are used for achieving the keyboard functions such as Start-Of-Line, End-Of-Line, Insert/Rewrite, Table, Delete, Backspace, Shift, Control, Select, Window and Function Combination;
The key combinations include “/”, “*”, “=”, “.”, “−”, “+”, Enter, when combined with other keys, they can achieve different functions;
Multimedia functions include Browser, Email, Favorites, Multimedia Player, Mute, Stop, Previous, Next, Play/Pause, Calculator, Volume − and Volume +;
When inputting the current language, the characters and symbols can be input using the ten numeric keys 0˜9 according to the required language to meet the keyboard input requirements for various languages;
Below the keyboard are the mouse wheel, left/right keys, cursor control device, as well as three key indicators: Num Lock, Caps Lock and Screen Lock, the mouse and cursor can be easily operated by simply moving down the right thumb;
The screen can be set through the top of the keyboard to display the input content; The relevant purposes can be added depending on the industry; The numeric keyboard can be used as an operation keyboard for small and micro products;
3) A mouse with a numeric keyboard, wherein the functions of the mouse and the numeric keyboard can be combined skillfully, with the mouse on the top and the numeric keyboard on the bottom, the operations can be completed with one or both hands;
The mouse on the top includes a mouse wheel, left/right keys and a cursor control device for controlling the cursor by moving the mouse, the cursor can also be controlled by shaking the cursor control device on the upper left without moving the mouse, the cursor control device can be either a component with an optical lens on both upper and lower parts, respectively, or a combination of two optical lens components;
The numeric keyboard on the bottom includes click keys, long-press keys and key combinations;
The click keys involve ten character keys 0˜9 and mathematical operation symbol keys “/”, “*”, “.”, “+”, “−” and “=”, as well as Space and Enter;
The long-press keys include Start-Of-Line, End-Of-Line, Page Up, Page Down, Insert/Rewrite, Table, Cursor Left/Right/Up/Down, Delete, Backspace, Shift, Control, Select, Window and Function Combination;
The key combinations include “/”, “*”, “=”, “.”, “−”, “+”, Enter, wWhen combined with other keys, they can achieve different functions;
Multimedia functions include Browser, Email, Favorites, Multimedia Player, Mute, Stop, Previous, Next, Play/Pause, Calculator, Volume − and Volume +;
When inputting the current language, the characters and symbols can be input using the ten numeric keys 0˜9 according to the required language to meet the keyboard input requirements for various languages;
The three indicators on the numeric keyboard, from left to right, are used for the Num Lock, Caps Lock and Screen Lock;
The relevant purposes can be added depending on the industry; The numeric keyboard can also be used as an operation keyboard for small and micro products;
4) Relevant functions of the numeric keyboard involved in the numeric keyboard with a mouse and the mouse with a numeric keyboard;
\textcircled{1} When the Num Lock indicator is on (the Num Lock indicator is on automatically after the computer is started), the following functions will be achieved:
(1) Input characters:

| | | Input | | Input | |
|---|---|---|---|---|---|
| Input | Key | semantic | Key | phrase | Key |
| character | operation | sym. | operation | character | operation |
| 0 | Click 0 | \dot{⁰} | 0 plus 1 | ⁰̅ | 0 plus 2 |
| 1 | Click 1 | \dot{¹} | 1 plus 0 | ¹̅ | 1 plus 2 |
| 2 | Click 2 | \dot{²} | 2 plus 0 | ²̅ | 2 plus 1 |
| 3 | Click 3 | \dot{³} | 3 plus 0 | ³̅ | 3 plus 1 |
| 4 | Click 4 | \dot{⁴} | 4 plus 5 | ⁴̅ | 4 plus 6 |
| 5 | Click 5 | \dot{⁵} | 5 plus 4 | ⁵̅ | 5 plus 6 |
| 6 | Click 6 | \dot{⁶} | 6 plus 4 | ⁶̅ | 6 plus 5 |
| 7 | Click 7 | \dot{⁷} | 7 plus 8 | ⁷̅ | 7 plus 9 |
| 8 | Click 8 | \dot{⁸} | 8 plus 7 | ⁸̅ | 8 plus 9 |
| 9 | Click 9 | \dot{⁹} | 9 plus 7 | ⁹̅ | 9 plus 8 |

(2) Input numbers
Key combination/plus 0, 1, 2, 3, 4, 5, 6, 7, 8 and 9 refer to inputting the numbers ⋅0, ⋅1, ⋅2, ⋅3, ⋅4, ⋅5, ⋅6, ⋅7, ⋅8 and ⋅9 respectively; After long pressing +, the numbers can be input directly by clicking the numeric keys;
(3) Input symbols
Key combination Enter plus 0, 1, 2, 3, 4, 5, 6, 7, 8, 9, “/”, “*”, “=”, “.”, “−” and “+” refer to inputting the shift symbols of the corresponding keys;
Key combination/plus *input sysmbol*,/plus Enter refers to inputting the shift symbol of Enter;
(4) Combination functions of Key Combination “=”:

| 12 | Keyboard |
|---|---|
| functions | operation |
| Function 1 | = plus 1 |
| Function 2 | = plus 2 |
| Function 3 | = plus 3 |
| Function 4 | = plus 4 |
| Function 5 | = plus 5 |
| Function 6 | = plus 6 |
| Function 7 | = plus 7 |
| Function 8 | = plus 8 |
| Function 9 | = plus 9 |
| Function 10 | = plus 0 |
| Function 11 | = plus * |
| Function 12 | = plus / |

(5) Combination functions of Key Combination “.”:

| Multimedia | Keyboard |
|---|---|
| function | operation |
| Web Page | . plus 1 |
| Email | . plus 2 |
| Favorites | . plus 3 |
| Multimedia | . plus 4 |
| Player | |
| Mute | . plus 5 |
| Previous | . plus 6 |
| Next | . plus 7 |
| Play/Pause | . plus 8 |
| Stop | . plus 9 |
| Calculator | . plus 0 |
| Volume − | . plus / |
| Volume + | . plus * |

(6) Combination functions of Key Combination -:

| Related | Keyboard |
|---|---|
| function | operation |
| Num Lock Switch | - plus 0 |
| Caps Lock Switch | - plus 1 |
| Screen Lock | - plus 2 |
| Exit | - plus 3 |
| Pause | - plus 4 |
| Screenshot | - plus 5 |
| Deleting the | - plus 6 |
| selected item | |
| directly | |

(7) Combination functions of Key Combination +:

| Related function | Keyboard operation |
|---|---|
| Select All | + plus 0 |
| Bold | + plus 0 plus 1 |
| Copy | + plus 1 |
| Font Format | + plus 1 plus 2 |
| Center alignment | + plus 2 |
| Search | + plus 2 plus 0 |
| Position | + plus 2 plus 1 |
| Replace | + plus 3 |
| Italic | + plus 3 plus 0 |
| Double-End Alignment | + plus 3 plus 1 |
| Hyperlink | + plus 4 |
| Left Alignment | + plus 4 plus 0 |
| left Indent | + plus 4 plus 1 |
| New | + plus 5 |
| Open | + plus 5 plus 0 |
| Print | + plus 5 plus 1 |
| Cancel Paragraph Format | + plus 6 |
| Right Alignment | + plus 6 plus 0 |
| Save | + plus 7 |
| Cut | + plus 7 plus 4 |
| First Line Indent | + plus 8 |
| Underline | + plus 8 plus 4 |
| Cancel | + plus 8 plus 5 |
| Paste | + plus 9 |
| Close | + plus 9 plus 4 |
| Restore | + plus 9 plus 5 |
| Input Method Conversion | + plus Enter |
| Character/Number Switching | + plus = |
| SBC Case/DBC Case Conversion | + plus - |

(8) The combination functions of Key Combination * are pending;
\textcircled{2} When the Num Lock indicator is off
(1) Input letters
The “formal symbol table of the digitized new language” according to claim 1, for the letter input of various current languages, all letters of the desired languages are arranged through the ten numeric keys 0˜9, the detailed method is as follows:

| Input of | |
|---|---|
| the 1^{st} letter | Input of the 2~8^{th} letters |
| Click 0 | Input the 2~8^{th} letters through “0 plus |
| | 1, 2, 3, 4, 5, 6 and *”, respectively |
| Click 1 | Input the 2~8^{th} letters through “1 plus |
| | 0, 2, 3, 4, 5, 6 and *”, respectively |
| Click 2 | Input the 2~8^{th} letters through “2 plus |
| | 0, 1, 3, 4, 5, 6 and *”, respectively |
| Click 3 | Input the 2~8^{th} letters through “3 plus |
| | 0, 1, 2, 4, 5, 6 and *”, respectively |
| Click 4 | Input the 2~8^{th} letters through “4 plus |
| | 0, 1, 2, 3, 5, 6 and *”, respectively |
| Click 5 | Input the 2~8^{th} letters through “5 plus |
| | 0, 1, 2, 3, 4, 6 and *”, respectively |
| Click 6 | Input the 2~8^{th} letters through “6 plus |
| | 0, 1, 2, 3, 4, 5 and *”, respectively |
| Click 7 | Input the 2~8^{th} letters through “7 plus |
| | 4, 5, 6, *, 8, 9 and /”, respectively |
| Click 8 | Input the 2~8^{th} letters through “8 plus |
| | 4, 5, 6, *, 7, 9 and /”, respectively |
| Click 9 | Input the 2~8^{th} letters through “9 plus |
| | 4, 5, 6, *, 7, 8 and /”, respectively |

When the Caps Lock indicator is on, capital letters can be input according to the above method;
(2) The combination functions of Key Combination “/”, “*”, “=”, “.”, “−”, “+” and Enter are pending;
5) The new Braille mobile phone keyboard
A new Braille keyboard includes ten blind symbols, representing ten dialing keys (0, 1, 2, 3, 4, 5, 6, 7, 8 and 9), respectively, “*” is used for dialing out, “/” is used for receiving incoming calls, voice prompts are provided when pressing the keys.
